(19) United States
(12) Patent Application Publication
(10) Pub. No.: US 2013/0258481 A1
(43) Pub. Date: Oct. 3, 2013

(54) ANTIGLARE FILM, METHOD FOR PRODUCING THE SAME, POLARIZING PLATE AND IMAGE DISPLAY DEVICE

(71) Applicant: FUJIFILM CORPORATION, Tokyo (JP)

(72) Inventors: Kenichi FUKUDA, Kanagawa (JP); Takata SUZUKI, Kanagawa (JP); Naoya NISHIMURA, Kanagawa (JP); Akira MARUYAMA, Kanagawa (JP)

(73) Assignee: FUJIFILM Corporation, Tokyo (JP)

(21) Appl. No.: 13/853,730

(22) Filed: Mar. 29, 2013

(30) Foreign Application Priority Data
Mar. 30, 2012 (JP) 2012-081573

(51) Int. Cl. C09D 5/00

(52) U.S. Cl. CPC C09D 5/006
USPC 359/601; 427/164

(57) ABSTRACT

An antiglare film includes an antiglare layer having a thickness of from 3 to 10 μm and a transparent support having a thickness from 20 to 70 μm, and the antiglare layer is formed by applying a composition containing the following components (A) to (D) on the transparent support, drying and curing the applied composition: (A) a resin particle having an average particle size of from 1.0 to 3.0 μm, (B) a curable compound having two or more curable functional groups in a molecule, (C) a smectite clay organic complex in which a smectite clay is intercalated with a quaternary ammonium salt represented by the formula (1) as defined herein, and (D) a volatile organic solvent.

### FIELD OF THE INVENTION

The present invention relates to an antiglare film including a transparent support and an antiglare layer which is formed from a composition containing a resin particle having an average particle size from 1.0 to 3.0 μm and a smectite clay organic complex intercalated with a quaternary ammonium salt having a specific structure and has a thickness from 3.0 to 10 μm, a method for producing the same, a polarizing plate having the antiglare hardcoat film and an image display device.

### BACKGROUND OF THE INVENTION

On a surface of image display device represented by a liquid crystal display device (LCD), an antiglare hardcoat film or an antiglare antireflective film is widely used as a surface film for the purpose of preventing reflection of outside light, lighting in a room or an image, for example, a viewer. As to such an antiglare hardcoat film, a film having an antiglare layer containing an ultraviolet-curable resin binder and a light-transmitting resin particle stacked on a transparent support film is currently the mainstream and as the antiglare antireflective film, a film further having an antireflective layer stacked on the antiglare layer thus-formed is used. With the popularization of the liquid crystal television, use of these image display devices increases and thus, various requirements, for example, improvement in visibility, high productivity or reduction in thickness are directed to the surface film.

One requirement for the improvement in visibility is improvement in the deterioration of denseness of black at the black display due to scattering of illumination light in a bright room or improvement in contrast in a bright room.

For example, an antiglare hardcoat film and an antiglare antireflective film each comprising an antiglare layer having an average thickness from 3 to 4 μm formed by using polystyrene particles having an average particle size of 3.5 μm is disclosed in JP-A-2002-196117 (the term “JP-A” as used herein means an “unexamined published Japanese patent application”). However, since the surface scattering strongly occurs as to the antiglare film, the denseness of black is remarkably low.

In response to the requirement, an antiglare hardcoat film and an antiglare antireflective film in which the decrease in contrast is suppressed while maintaining the antiglare property by using particles having an average particle size from 6 to 15 μm in an ultraviolet-curable resin binder, setting an average thickness of the antiglare layer from 15 to 35 μm and incorporating a specific binder to form a mild surface irregular shape is disclosed in Japanese Patent No. 4,116,045. However, according to the technique in Japanese Patent No. 4,116,045, since a thickness of the antiglare layer is large, due to cure shrinkage caused by ultraviolet ray irradiation at the formation of antiglare layer a curl is apt to occur and when the thickness of base film is reduced in view of a curl balance between the antiglare layer and the base film, the curl tends to further increase so that the problem of reduction in thickness of the surface film or polarizing plate requested in recent years can not be solved.

As the antiglare hardcoat film for solving the problem of reduction in thickness, an antiglare hardcoat film having a relatively mild surface irregular shape even when an average thickness of the antiglare layer thereof is 10 μm or less, wherein a first phase containing a high proportion of a resin component and a second phase containing a high proportion of an inorganic component are formed in the antiglare layer by using an inorganic stratiform compound and two kinds of specific solvents is disclosed in JP-A-2011-242759.

### SUMMARY OF THE INVENTION

However, as a result of conducting the retest as to JP-A-2011-242759, it has been found that since the second phase containing a high proportion of the inorganic component is formed by using two kinds of the specific solvents, aggregates of the inorganic component are apt to generate and inorganic aggregates are apt to occur whereby the surface tends to have textured feeling. On the contrary, when a solvent composition for uniformly dispersing the inorganic component is selected to control the formation of second phase, it is found that the antiglare property is not generated at all.

On the other hand, it has been hitherto performed to use a stratiform compound, for example, smectite in an antiglare layer as a thixotropic agent (see, for example, JP-A-2004-004417 and JP-A-2007-233185), however, there are no suggestions for forming an antiglare layer having a mild surface irregular shape.

To summarize, an antiglare hardcoat film has not yet been obtained, which has the mild surface irregular shape, exhibits a high contrast because of good denseness of black at the black display in a bright room, dose not have textured feeling on the surface, makes it possible to reduce thickness of the antiglare film by reduction in thickness of a transparent support even when a thickness of the antiglare layer is 10 μm or less, and is excellent in productivity.

An object of the present invention is to provide an antiglare film, which is excellent in the antiglare property, has good denseness of black at the black display in a bright room, dose not have textured feeling on the surface, exhibits a high contrast, is prevented from the occurrence of a curl even when a thickness of a transparent support is reduced, and is also excellent in productivity, and a method for producing thereof. Another object of the present invention is to provide a polarizing plate or image display device using the antiglare film.

As a result of the intensive investigations, the inventors have found that the problems described above can be fully solved by coating a composition containing (A) a resin particle having an average particle size from 1.0 to 3.0 μm, (B) a curable compound having two or more curable functional groups in a molecule, (C) a smectite clay organic complex intercalated with a quaternary ammonium salt having a specific structure, and (D) a volatile organic solvent, drying and curing to stuck an antiglare layer has a thickness from 3.0 to 10 μm on one surface of a transparent support having an average thickness from 20 to 70 μm, to complete the present invention.

The objects of the invention described above can be achieved by the means described below.

(1) An antiglare film comprising an antiglare layer having a thickness from 3 to 10 μm and a transparent support having a thickness from 20 to 70 μm, wherein the antiglare layer is formed by applying (coating) a composition containing (A) to (ID) shown below on the transparent support, drying and curing the applied composition:
(A) a resin particle having an average particle size from 1.0 to 3.0 μm,
(B) a curable compound having two or more curable functional groups in a molecule,
(C) a smectite clay organic complex in which a smectite clay is intercalated with a quaternary ammonium salt represented by formula (I) shown below, and
(D) a volatile organic solvent.

[(R¹)₃(R²)N]⁺.X⁻ (1)

In formula (I), R¹ and R² are not the same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.

(2) The antiglare film as described in (1) above, wherein the antiglare layer does not undergo phase separation.
(3) The antiglare film as described in (1) or (2) above, wherein R¹ in formula (I) is an alkyl group having from 6 to 10 carbon atoms.
(4) The antiglare film as described in any one of (1) to (3) above, wherein R² in formula (I) is an alkyl group having 1 or 2 carbon atoms.
(5) The antiglare film as described in any one of (I) to (4) above, wherein a content of the smectite clay organic complex (C) is from 0.5 to 2.0% by weight in the antiglare layer.
(6) The antiglare film as described in any one of (1) to (5) above, wherein a content of the quaternary ammonium salt in the smectite clay organic complex (C) is from 0.95 to 1.05 times of a cation exchange capacity.
(7) The antiglare film as described in any one of (1) to (6) above, wherein a thickness of the antiglare layer is from 3 to 6 μm.
(8) The antiglare film as described in any one of (1) to (7) above, wherein the smectite clay organic complex (C) is uniformly dispersed in the antiglare layer.
(9) The antiglare film as described in any one of (1) to (8) above, wherein the resin particle (A) is a particle of a copolymer of styrene and methyl methacrylate and a refractive index thereof is from 1.50 to 1.54.
(10) The antiglare film as described in any one of (1) to (9) above, which comprises a low refractive index layer having a refractive index lower than that of the transparent support on the antiglare layer.
(11) The antiglare film as described in any one of (1) to (10) above, which is used as a surface film for liquid crystal display device.
(12) A polarizing plate comprising at least one protective film and a polarizing film, wherein at least one of the protective films is the antiglare film as described in any one of (1) to (11) above and a surface of the antiglare film on a side of the transparent support is stacked on the polarizing film.
(13) An image display device comprising at least one of the antiglare films as described in any one of (1) to (11) above or the polarizing plate as described in (12) above.
(14) A method for producing an antiglare film comprising: forming an antiglare layer having a thickness from 3 to 10 μm on one surface of a transparent support having a thickness from 20 to 70 μm by applying (coating) a composition containing (A) to (D) shown below on the transparent support, and drying and curing the applied composition:
(A) a resin particle having an average particle size from 1.0 to 3.0 μm,
(B) a curable compound having two or more curable functional groups in a molecule,
(C) a smectite clay organic complex in which a smectite clay is intercalated with a quaternary ammonium salt represented by formula (I) shown below, and
(D) a mixed solvent containing two or more kinds of ketone solvents.

[(R¹)₃(R²)N]⁺.X⁻ (1)

In formula (I), R¹ and R² are not the same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.

According to the present invention, an antiglare film, which is excellent in the antiglare property, exhibits a high contrast because of good denseness of black at the black display in a bright room, dose not have textured feeling on the surface, is prevented from the occurrence of a curl even when a thickness of a transparent support is reduced, and is also excellent in productivity, and a method for producing thereof can be provided. Also, a polarizing plate and image display device using the antiglare film can be provided.

### BRIEF DESCRIPTION OF THE DRAWINGS

FIG. 1 is a view showing an example for measuring a curl of an optical film according to the method of ANSI/ASC PH1.29-1985, Method A).

### DETAILED DESCRIPTION OF THE INVENTION

The mode for carrying out the invention is described in detail below, but the invention should not be construed as being limited thereto. In the specification, in the case where a numerical value represents a physical property value, a characteristic value or the like, the expression of “(numerical value 1) to (numerical value 2)” means a value ranging from “(numerical value 1)” or more to “(numerical value 2) or less”. Also, in the specification, the term “(meth)acrylate” means “at least any of acrylate and methacrylate”. The same is also applied to the terms “(meth)acryloyl group”, “(meth)acrylic acid” and the like.

### [Antiglare Film]

The antiglare film according to the invention comprises an antiglare layer having a thickness from 3 to 10 μm and a transparent support having a thickness from 20 to 70 μm, wherein the antiglare layer is formed by coating a composition containing (A) to (I) shown below on the transparent support, drying and curing:

(A) a resin particle having an average particle size from 1.0 to 3.0 μm,
(B) a curable compound having two or more curable functional groups in a molecule,
(C) a smectite clay organic complex in which a smectite clay is intercalated with a quaternary ammonium salt represented by formula (I) shown below, and
(D) a volatile organic solvent.

[(R¹)₃(R²)N]⁺.X⁻ (1)

In formula (I), R¹ and R² are not the same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.

The reason for obtaining the antiglare film, which is excellent in the antiglare property, has good denseness of black at the black display in a bright room, dose not have textured feeling on the surface, exhibits a high contrast, is prevented from the occurrence of a curl even when a thickness of a transparent support is reduced, and is also excellent in productivity, is not quite clear but is presumed as described below.

Specifically, in the composition containing a resin particle (A), a curable compound having two or more curable functional groups in the molecule (B), a smectite clay organic complex intercalated with a quaternary ammonium salt having a specific structure (C), and a volatile organic solvent (D), the resin particle (A) and the smectite clay organic complex intercalated with a quaternary ammonium salt having a specific structure (C) can be uniformly dispersed so that the composition can be coated in the state of uniform dispersion on one surface of a transparent support. Then, by drying of the volatile organic solvent (D) the resin particle (A) can be aggregated to a suitable extent by the function of the smectite clay organic complex intercalated with a quaternary ammonium salt having a specific structure (C), which is uniformly dispersed in the antiglare layer, and thus, it is presumed that the excellent antiglare property can be achieved even when the resin particle (A) is a fine particle having an average particle size from 1.0 to 3.0 μm.

Thereafter, by forming an antiglare layer having a thickness from 3.0 to 10 μm with curing, it is presumed that due to the aggregation of the resin particle (A) to a suitable extent by the function of the smectite clay organic complex (C) uniformly dispersed in the antiglare layer, a mild surface irregular shape is formed on the surface of the antiglare layer, thereby achieving good denseness of black at the black display in a bright room, no textured feeling on the surface, and a high contrast.

Since the antiglare layer is a thin layer having a thickness from 3.0 to 10 μm, it is believed that a curl due to the cure shrinkage hardly occurs so that a thickness of the transparent support can be set from 20 to 70 μm. Thus, the reduction in thickness of the antiglare film can be achieved and it is believed that the productivity is also excellent.

[(A) Resin Particle Having Average Particle Size from 1.0 to 3.0 μm]

The composition which is used for the formation of antiglare layer according to the invention contains a resin particle having an average particle size from 1.0 to 3.0 μm. The resin particle exhibits a specific state of being in the antiglare layer and is used for forming a suitable surface state of the antiglare layer having a thickness from 3.0 to 10.0 μm. The average particle size of the resin particle according to the invention is from 1.0 to 3.0 μm, preferably from 1.0 to 2.5 μm, and most preferably from 1.0 to 2.0 μm.

As means for adjusting the surface state of the antiglare layer to the specific range according to the invention, two or more kinds of particles having average particle sizes different from each other may be used together.

As a method for measuring an average particle size of the resin particle, an appropriate measuring method can be utilized as long as it is a method for measuring a particle size of particle and a method in which a particle size distribution of particle is measured by a Coulter counter method, the distribution measured is converted into a particle number distribution, and the average particle size is calculated from the particle distribution obtained or a method in which 100 particles are observed by a transmission electron microscope (with magnification ranging from 15,000 to 150,000) and the average value thereof is considered as the average particle size is used.

The resin particle according to the invention is preferably a spherical particle. As long as the purpose of the invention is achieved, an amorphous particle may be used. In case of the amorphous particle, the particle size is expressed using a diameter corresponding to the diameter of a sphere.

Also, internal scattering can be imparted by controlling a refractive index difference between the resin particle and a binder. Since decrease in contrast is accompanied when the refractive index difference is too large, an absolute value of the refractive index difference between the resin particle and a binder component of the antiglare layer exclusive of the resin particle is designed preferably 0.050 or less, more preferably from 0.000 to 0.030, particularly preferably from 0.000 to 0.020, and most preferably from 0.000 to 0.010. By designing the absolute value of the refractive index difference in the range described above, a high contrast can be obtained. In the case of using two or more kinds of the resin particles together, the refractive indexes may be the same or different from each other.

The refractive index of the resin particle is preferably from 1.46 to 1.65, more preferably from 1.49 to 1.60, and particularly preferably from 1.50 to 1.54. By setting the refractive index in the range described above, the antiglare layer excellent in the antiglare property can be obtained.

The refractive index of the resin particle can be determined by dispersing the light-transmitting resin particles in an equal amount in solvents prepared by changing a mixing ratio of two kinds of solvents having different refractive indexes appropriately selected from methylene iodide, 1,2-dibromopropane and n-hexane, thereby varying the refractive index to measure turbidity and measuring the refractive index of the solvent where the turbidity is minimum by an Abbe refractometer.

Specific examples of the resin particle include a resin particle, for example, a crosslinked polymethyl methacrylate particle, a crosslinked methyl methacrylate-styrene copolymer particle, a crosslinked polystyrene particle, a crosslinked methyl methacrylate-methyl acrylate copolymer particle, a crosslinked alkyl acrylate-styrene copolymer particle, a crosslinked alkyl methacrylate-styrene copolymer particle, a melamine/formaldehyde resin particle and a benzoguanamine/formaldehyde resin particle. Among them, a crosslinked polystyrene particle, a crosslinked polymethyl methacrylate particle or a crosslinked methyl methacrylate-styrene copolymer particle is preferred. Further, a surface modified particle in which a compound containing a fluorine atom, a silicon atom, a carboxyl group, a hydroxy group, an amino group, a sulfonic acid group, a phosphoric acid group or the like is chemically connected to the surface of the resin particle, or a particle in which a nano-sized inorganic fine particle, for example, silica or zirconia is connected to the surface of the resin particle may also be exemplified.

Of the resin particles, in order to adjust the absolute value of the refractive index difference between the resin particle and the binder component in the antiglare layer, a crosslinked methyl methacrylate-styrene copolymer particle, a crosslinked alkyl acrylate-styrene copolymer particle or a crosslinked alkyl methacrylate-styrene copolymer particle is preferred.

As to the resin particle which can be used in the invention, although one kind thereof is able to sufficiently control the surface shape, it is not precluded to use two or more kinds thereof together. According to the invention, in the case where plural kinds of the resin particles are used, it is preferred to use the resin particles having only different average particle sizes without changing a monomer composition for forming the resin particles because change in interaction between the particles is small and the control of the surface shape is easy.

According to the invention, it is particularly preferred that the resin particle (A) is a crosslinked styrene-methyl methacrylate copolymer particle and a refractive index thereof is from 1.50 to 1.54.

The content of the resin particle (A) is preferably from 1.0 to 8.0% by weight, more preferably from 1.0 to 6.0% by weight, most preferably from 2.0 to 5.5% by weight, based on the total solid content of the coating composition for antiglare layer from the standpoint of provision of the antiglare property, the denseness of black and the decrease in textured feeling.

By using the resin particle having an average particle size from 1.0 to 3.0 μm in an amount smaller than that in the prior art, the resin particles in the antiglare layer are prevented from unnecessary contact with each other and arranged with overlapping each other in a vertical direction so that the surface shape of the antiglare layer according to the invention can be achieved.

According to the invention, a value T/R, a ratio of [thickness T of antiglare layer]/[average particle size R of Resin particle (A)], is preferably from 2.0 to 5.0 in order to realize the state of being of the resin particle in the antiglare layer according to the invention, and it is more preferably from 2.2 to 4.0, and most preferably from 2.3 to less than 3.5. When the value T/R is 2.0 or more, the surface shape of the antiglare layer is hardly influenced directly by the resin particle to prevent the occurrence of component having a high tilt angle, whereby the denseness of black is improved, the textured feeling is decreased, and coated surface failure due to coarse particles existing in an extremely low frequency is hard to occur. When the value T/R is 5.0 or less, it is not necessary to aggregate a large amount of the resin particles in order to influence onto the surface shape of the antiglare layer, whereby the control of aggregation is conducted with ease.

### [(B) Curable Compound Having Two or More Curable Functional Groups in Molecule (Hereinafter, Also Simply Referred to as Curable Compound (B))]

The coating composition for forming antiglare layer according to the invention contains a curable compound (B). The curable compound becomes a light-transmitting resin after curing to be able to act as a resin binder forming a matrix constituting the antiglare layer.

The curable functional group contained in the curable compound includes, for example, a vinyl group, an allyl group, a (meth)acryloyl group, a glycidyl group and an epoxy group.

The curable compound includes, for example, an ionizing radiation-curable compound and a heat-curable compound and is preferably an ionizing radiation-curable compound.

The curable compound is preferably an ethylenically unsaturated monomer described below.

Examples of the monomer having two or more ethylenically unsaturated groups include an ester of polyhydric alcohol and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate or 1,2,3-cyclohexane tetramethacrylate, vinylbenzene and a derivative thereof (for example, 1,4-divinylbenzene, 2-acryloylethyl 4-vinylbenzoate or 1,4-divinylcyclohexanone), a vinylsulfone (for example, divinylsulfone) and a (meth)acrylamide (for example, methylenebisacrylamide). As the polyfunctional acrylate compound having (meth)acryloyl groups (ester of polyhydric alcohol and (meth)acrylic acid), commercially available product may also be used and examples thereof include KAYARAD DPHA and KAYARAD PET-30 produced by Nippon Kayaku Co., Ltd., and NK ESTER A-TMMT, NK ESTER A-TMPT and NK ESTER A-DPH produced by Shin-Nakamura Chemical Co., Ltd. From the standpoint of inhibition of curl by the reduction of cure shrinkage, it is preferred to increase a distance between the crosslinking points by adding ethylene oxide, propylene oxide or caprolactone and, for example, ethylene oxide-added trimethylolpropane triacrylate (for example, BISCOAT V#360 produced by Osaka Organic Chemical Industry Ltd.), glycerol propylene oxide-added triacrylate (for example, V#GPT produced by Osaka Organic Chemical Industry Ltd.) and caprolactone-added dipentaerythritol hexaacrylate (for example, DPCA-20 and DPCA-120 produced by Nippon Kayaku Co., Ltd.) are preferably used. It is also preferred to use together two or more kinds of the monomers having two or more ethylenically unsaturated groups.

As the curable compound having two or more curable functional groups other than those described above, a resin having two or more ethylenically unsaturated groups, for example, a polyester resin, a polyether resin, an acrylic resin, an epoxy resin, a urethane resin, an alkyd resin, a spiroacetal resin, a polybutadiene resin and a polythiol polyene resin each having a relatively low molecular weight and an oligomer or prepolymer of a polyfunctional compound, for example, a polyhydric alcohol are exemplified. Two or more kinds of the compounds may be used in combination.

Among them, a urethane acrylate, a polyester acrylate and an epoxy acrylate are preferably used.

The urethane acrylate is a monomer or oligomer obtained by reacting a diisocyanate, for example, tetramethylene diisocyanate (TDI), diphenylmethane diisocyanate (MDI), hexamethylene diisocyanate (HDI), isophorone diisocyanate (IPDI) or hexamethylene diisocyanate (HMDI) with a polyol, for example, (polypropylene oxide)diol, poly(tetramethylene oxide)diol, ethoxylated bisphenol A, ethoxylated bisphenol S spiroglycol, caprolactone-modified diol or carbonate diol) and a hydroxy acrylate (for example, 2-hydroxyethyl (meth)acrylate, 2-hydroxypropyl (meth)acrylate, glycidol di(meth)acrylate or pentaerythritol triacrylate), and includes polyfunctional urethane monomers described, for example, in JP-A-2002-25650, JP-A-2002-355936 and JP-A-2002-067238. Specific examples of the urethane acrylate include an adduct of TDI and hydroxyethyl acrylate, an adduct of IPDI and hydroxyethyl acrylate, an adduct of HDI and pentaerythritol triacrylate (PETA), a compound obtained by preparing an adduct of TDI and PETA and reacting the remaining isocyanate with dodecyloxyhydroxypropyl acrylate, an adduct of 6,6-nylon and TDI and an adduct of pentaerythritol, TDI and hydroxyethyl acrylate, but the invention should not be construed as being limited thereto.

Examples of commercially available product of the urethane (meth)acrylate which can be used in the invention include BEAMSET 102, 502H, 505A-6, 510, 550B, 551B, 575, 575CB, EM-90 and EM-92 (produced by Arakawa Chemical Industries, Ltd.), PHOTOMER 6008 and 6210 (produced by San Nopco, Ltd.), NK OLIGO U-2PPA, U-4HA, U-6HA, H-15HA, UA-32PA, U-324A, U-4H and U-6H (produced by Shin-Nakamura Chemical Co., Ltd.), ARONIX M-1100, M-1200, M-1210, M-1310, M-1600 and M-1960 (produced by Toagosci Co., Ltd.), AH-600, AT606 and UA-306H (produced by Kyoeisha Chemical Co., Ltd.), KAYARAD UX-2201, UX-2301, UX-3204, UX-3301, UX-4101, UX-6101 and UX-7101 (produced by Nippon Kayaku Co., Ltd.), SHIKO UV-1700B, UV-3000B, UV-6100B, UV-6300B, UV-7000 and UV-2010B (produced by Nippon Synthetic Chemical Industry Co., Ltd.), ART RESIN UN-1255, UN-5200, HDP-4T, HMP-2, UN-901T, UN-3320HA, UN-3320HB, UN-3320HC, UN-3320HS, H-61 and HDP-M20 (produced by Negami Chemical Industrial Co., Ltd.), and EBECRYL 6700, 204, 205, 220, 254, 1259, 1290K, 1748, 2002, 2220, 4833, 4842, 4866, 5129, 6602 and 8301 (produced by Daicel UBC Co., Ltd.).

The polyester acrylate is an acrylate obtained by condensing (meth)acrylic acid to a hydroxy group remaining in a polyester skeleton synthesized from a polyol and a dibasic acid. Specific examples thereof include a reaction product of phthalic anhydride/propylene oxide/acrylic acid, a reaction product of adipic acid/1,6-hexanediol/acrylic acid and a reaction product of trimellitic acid/diethylene glycol/acrylic acid, but the invention should not be construed as being limited thereto.

The epoxy acrylate is synthesized by a reaction of a compound having an epoxy group and (meth)acrylic acid, and representative epoxy acrylates are classified by the compound having an epoxy group into a bisphenol A type, a bisphenol S type, a bisphenol F type, an epoxidized oil type, a phenol novolac type and an alicyclic type. Specific examples thereof include an acrylate obtained by reacting acrylic acid with an adduct of bisphenol A and epichlorohydrin, an acrylate obtained by reacting epichlorohydrin with phenol novolac and reacting acrylic acid therewith, an acrylate obtained by reacting acrylic acid with an adduct of bisphenol S and epichlorohydrin, an acrylate obtained by reacting acrylic acid with an adduct of bisphenol S and epichlorohydrin and an acrylate obtained by reacting acrylic acid with an epoxidized soybean oil, but the invention should not be construed as being limited thereto.

As the curable compound having two or more ethylenically unsaturated groups, a monomer having different refractive index can be used in order to control the refractive index of the layer. Examples thereof having a particularly high refractive index include bis(4-methacryloylthiophenyl)sulfide, vinylnaphthalene, vinylphenylsulfide and 4-mathacryloxyphenyl-4′-methoxyphenyl thioether.

Further, a dendrimer described, for example, in JP-A-2005-76005 and JP-A-2005-36105 and a norbornene ring-containing monomer as described, for example, in JP-A-2005-60425 can also be used.

Polymerization of the curable compound having ethylenically unsaturated groups can be performed by irradiation with an ionization radiation or heating in the presence of a photo radical polymerization initiator or a thermal radical polymerization initiator. Therefore, the antiglare layer is formed by preparing a coating solution containing the curable compound having ethylenically unsaturated groups, a photo radical polymerization initiator or thermal radical polymerization initiator, the resin particle, a dispersing solvent and, if desired, an inorganic filler, a coating aid, other additives and the like, coating the coating solution on a transparent base material, and then curing by a polymerization reaction due to irradiation with an ionization radiation or heating. It is also preferred to conduct together the ionization radiation curing and the heat curing. As the photo polymerization initiator and thermal polymerization initiator, commercially available compounds can be employed.

The curable compound which can be used in the invention is preferably a mixture of a polyfunctional (meth)acrylate monomer having from 5 to 10 functional groups and a (meth)acrylate monomer having from 1 to 4 functional groups. By using at least two kinds of monomers as described above, viscosity of the coating composition can be set in a suitable range and it becomes easy for the resin particles to be arranged preferably.

The content of the curable compound is preferably from 60 to 99% by weight, more preferably from 70 to 97% by weight, still more preferably from 80 to 95% by weight, based on the total solid content of the coating composition for forming antiglare layer, from the standpoint of film strength of the antiglare layer.

According to the invention, the refractive index of the antiglare layer exclusive of the resin particle is preferably from 1.46 to 1.65, more preferably from 1.49 to 1.60, and particularly preferably from 1.49 to 1.53. By setting the refractive index in the range described above, coating unevenness or interference unevenness are made not conspicuous and the antiglare layer having high hardness can be obtained.

The refractive index of the antiglare layer exclusive of the resin particle can be quantitatively determined by directly measuring by an Abbe refractometer or by measuring a spectral reflectance spectrum or spectral ellipsometry.

In order to obtain the antiglare layer having a high refractive index, it is preferred that the monomer contains an aromatic ring or at least one atom selected form a halogen atom exclusive of a fluorine atom, a sulfur atom, a phosphorus atom and a nitrogen atom in the structure thereof.

### [(C) Smectite Clay Organic Complex]

The composition for forming antiglare layer according to the invention contains a smectite clay organic complex (C) in which a smectite clay is intercalated with a quaternary ammonium salt represented by formula (I) shown below.

[(R¹)₃(R²)N]⁺.X⁻ (1)

In formula (I), R¹ and R² are not the same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.

By using the smectite clay organic complex (C) having a quaternary ammonium salt represented by formula (I) shown above intercalated therein, which is uniformly dispersed in the antiglare layer, the resin particle (A) can be aggregated to a suitable extent in the antiglare layer and thus, the excellent antiglare property can be achieved even when the resin particle (A) is a fine particle having an average particle size from 1.0 to 4.5 μm and a mild surface irregular shape is formed on the surface of the antiglare layer, thereby achieving the improvement in denseness of black and the decrease in textured feeling.

The three R¹ are the same and R¹ is preferably an alkyl group. The number of carbon atoms of R¹ is from 4 to 24, preferably from 6 to 20, more preferably from 6 to 18, and particularly preferably from 6 to 10.

R² is preferably an alkyl group. The number of carbon atoms of R² is from 1 to 10, preferably from 1 to 8, more preferably from 1 to 6, and still more preferably 1 or 2.

Also, both R¹ and R¹ are preferably alkyl groups.

Specific examples of the ammonium ion in formula (I) described above include a trioctyl methyl ammonium ion, a tristearyl ethyl ammonium ion, a trioctyl ethyl ammonium ion, a tristearyl methyl ammonium ion, a tridecyl hexyl ammonium ion and a tritetradecyl propyl ammonium ion. Among them, a trioctyl methyl ammonium ion or a tristearyl ethyl ammonium ion is preferred.

In formula (I) described above, X⁻ represents an anion. Examples of the anion include Cl⁻, Br⁻, OH⁻ and NO₃⁻. Among them, Cl⁻ or Br⁻ is preferred, and Cl⁻ is more preferred.

The cation exchange capacity of smectite clay which forms the smectite clay organic complex (C) is preferably from 70 to 200 milliequivalent, more preferably from 85 to 130 milliequivalent, still more preferably from 95 to 115 milliequivalent, per 100 g of the clay.

The content of non-clay impurity in the smectite clay which can be used in the invention is preferably 10% by weight or less.

As the method for obtaining the clay organic complex by intercalation of a quaternary ammonium salt in a smectite clay, for example, a method of ion exchange between an exchangeable cation (for example, a sodium ion) of smectite clay and an ammonium ion, for example, a trioctyl methyl ammonium ion is exemplified.

More specifically, a method of adding a quaternary ammonium salt to a suspension of smectite clay prepared by dispersing the smectite clay in water, followed by being reacted is exemplified. The solid (smectite clay) dispersion concentration in the suspension is not particularly restricted as far as it is in a range where the smectite clay is capable of being dispersed and is preferably approximately from 1 to 5% by weight. In this case, a smectite clay previously freeze dried may also be used.

The amount of the quaternary ammonium salt added is preferably adjusted so as to make the cation exchange capacity of smectite clay equivalent to the quaternary ammonium ion, but the production can be performed using a smaller amount than the cation exchange capacity, or the amount of quaternary ammonium salt exceeding the cation exchange capacity may also be added. Specifically, the amount of quaternary ammonium ion is preferably from 0.5 to 1.5 times (in terms of milliequivalent), more preferably from 0.8 to 1.2 times, of the cation exchange capacity of smectite clay.

The reaction temperature of smectite clay and quaternary ammonium salt is preferably not higher than a decomposition point of the quaternary ammonium salt.

After the reaction, the solid is separated from the liquid, the clay organic complex prepared is washed with water or hot water to remove the electrolyte subsidiary produced and dried and, if desired, pulverized to obtain the clay organic complex.

The preparation of clay organic complex can be confirmed by selecting a method utilizing chemical analysis, X-ray diffraction, NMR, infrared absorption spectrum, thermobalance, differential thermal analysis, theology of high polar solvent system, swelling property in high polar organic solvent, color tone or the like depending on the purpose and appropriately combining thereof.

For example, in the method utilizing X-ray diffraction, the preparation of clay organic complex can be easily confirmed by measuring reflection amount of (001) plane. While the basal spacing of smectite clay which is a raw material may be 10 angstroms in the state of dehydration and may be from 12 to 16 angstroms under ordinary temperature and humidity conditions, the basal spacing of the smectite clay organic complex (C) according to the invention may be approximately 18 angstroms.

The content of the smectite clay organic complex (C) is preferably from 0.2 to 8.0% by weight, more preferably from 0.3 to 4.0% by weight, still more preferably from 0.4 to 3.0% by weight, particularly preferably from 0.5 to 2.0% by weight, based on the total solid content of the antiglare layer.

### [(D) Volatile Organic Solvent]

A volatile organic solvent is contained in the coating composition for forming the antiglare film according to the invention. As the volatile organic solvent, a various kind of solvent can be used by taking in consideration that each component is capable of being dissolved or dispersed, that a uniform state of layer is easily formed in a coating step and a drying step, that solution preservability can be secured, and that it has an appropriate saturated vapor pressure.

One kind of the solvent or a mixture of two or more kinds of the solvents may be used. In order to change the solvent composition in a coated layer in the process of drying and thereby to change the state of being of the resin particle and the smectite clay organic complex, it is preferred to use two kinds of solvents having different boiling points and it is also preferred to use together a solvent having a boiling point lower than 100° C. at a normal pressure and a solvent having a boiling point of 100° C. or higher at a normal pressure.

Examples of the solvent having a boiling point of lower than 100° C. include a hydrocarbon, for example, hexane (boiling point: 68.7° C.), heptane (98.4° C.), cyclohexane (80.7° C.) or benzene (80.1° C.), a halogenated hydrocarbon, for example, dichloromethane (39.8° C.), chloroform (61.2° C.), carbon tetrachloride (76.8° C.), 1,2-dichloroethane (83.5° C.) or trichloroethylene (87.2° C.), an ether, for example, diethyl ether (34.60° C.), diisopropyl ether (68.5° C.), dipropyl ether (90.5° C.) or tetrahydrofuran (66° C.), an ester, for example, ethyl formate (54.2° C.), methyl acetate (57.8° C.), ethyl acetate (77.1° C.), isopropyl acetate (89° C.) or dimethyl carbonate (90.4° C.), a ketone, for example, acetone (56.1° C.) or 2-butanone (same as methyl ethyl ketone (MEK), 79.6° C.), an alcohol, for example, methanol (64.5° C.), ethanol (78.3° C.), 2-propanol (82.4° C.) or 1-propanol (97.2° C.), cyano compound, for example, acetonitrile (81.6° C.) or propionitrile (97.4° C.), and carbon disulfide (46.2° C.). Among them, a ketone or an ester is preferred, and a ketone is particularly preferred. Of the ketones, 2-butanone is particularly preferred.

Examples of the solvent having a boiling point of 100° C. or higher include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (same as methyl isobutyl ketone (MIBK), 115.9° C.), 1-butanol (117.7° C.), N,N-dimethylformamide (153° C.), N,N-dimethylacetamide (166° C.) and dimethylsulfoxide (189° C.). Among them, cyclohexanone or 2-methyl-4-pentanone is preferred.

The volatile organic solvent (D) according to the invention is particularly preferably a mixed solvent containing two or more kinds of ketone solvents. By using the mixed solvent containing two or more kinds of ketone solvents, each component (in particular, the resin particle (A) or the smectite clay organic complex (C)) can be particularly preferably dissolved or dispersed and in the drying step, the aggregation of the resin particle (A) due to the smectite clay organic complex (C) can be achieved to a particularly suitable extent and as a result, the decrease in textured feeling, the improvement in denseness of black and the impartation of antiglare property can be more steadily achieved even when the antiglare layer is a thin layer having a thickness from 3 to 10 μm.

The mixed solvent containing two or more kinds of ketone solvents may contain a solvent other than the ketone solvents but the content of the solvent other than the ketone solvents is preferably 5% by weight or less, more preferably 1% by weight or less, based on the total weight of the solvents and ideally, it is particularly preferred that the solvent other than the ketone solvents is not contained.

From the standpoint of making change the solvent composition in a coated layer in the process of drying and thereby to change effectively the state of being of the resin particle and the smectite clay organic complex (C), it is preferred to use two kinds of ketone solvents having different boiling points and it is preferred to use together a ketone solvent having a boiling point lower than 100° C. at a normal pressure and a ketone solvent having a boiling point of 100° C. or higher at a normal pressure.

A mixing ratio of the ketone solvent having a boiling point lower than 100° C. at a normal pressure and the ketone solvent having a boiling point of 100° C. or higher at a normal pressure is preferably from 1:99 to 60:40, more preferably from 10:90 to 50:50, and still more preferably from 10:90 to 30:70.

Examples of the ketone solvent having a boiling point lower than 100° C. include a ketone solvent, for example, acetone or 2-butanone. Among them, 2-butanone is preferred.

Examples of the ketone solvent having a boiling point of 100° C. or higher include cyclohexanone and 2-methyl-4-pentanone. Cyclohexanone or 2-methyl-4-pentanone is preferred.

Although the coating composition which can be used for forming the antiglare layer according to the invention comprises the components (A), (B) and (C) described above as the essential components, it is preferred to prepare a dispersion obtained by previously dispersing the resin particle (A) and the smectite clay organic complex (C) in the solvent described above and then to mix the component (B) and other additives with the dispersion. By previously dispersing the component (A) and component (C) to prepare the dispersion, dissolution defect or undesirable aggregation at the time of preparation of the coating composition can be prevented.

The solid content concentration of the coating composition which can be used for forming the antiglare layer according to the invention is preferably from 10 to 80% by weight, and more preferably from 20 to 60% by weight.

### [Organic Polymer Thickener]

The curable composition for forming the antiglare layer according to the invention may contain an organic polymer thickener.

The thickener as used herein means a material capable of increasing the viscosity of a solution upon addition of the same. A degree of increase in the viscosity of the coating solution by the addition of organic polymer thickener is preferably from 1 to 50 mPa·s, and more preferably from 5 to 15 mPa·s.

As the organic polymer thickener, a cellulose ester is preferred in the invention. Above all, cellulose acetate butyrate is particularly preferred.

The molecular weight of the organic polymer thickener is preferably from 3,000 to 400,000, more preferably from 4,000 to 300,000, particularly preferably from 5,000 to 200,000, in terms of a number average molecular weight.

The content of the organic polymer thickener is preferably from 0.5 to 10% by weight, more preferably from 1.0 to 7.0% by weight, particularly preferably from 2.0 to 5.0% by weight, based on the total solid content of the curable composition for forming the antiglare layer.

### [Photopolymerization Initiator]

The polymerization of the curable compound (B) (for example, monomer having ethylenically unsaturated groups) according to the invention can be performed by irradiation with an ionization radiation or heating in the presence of a photo radical polymerization initiator or a thermal radical polymerization initiator. Therefore, the antiglare layer is formed by preparing a coating solution containing the monomer having ethylenically unsaturated groups, a photo radical polymerization initiator or a thermal radical polymerization initiator and a particle and, if desired, an inorganic filler, a coating aid, other additives, an organic solvent and the like, coating the coating solution on a transparent support, and then curing by a polymerization reaction due to irradiation with an ionization radiation or heat. It is also preferred to conduct together the ionization radiation curing and the heat curing. As the photopolymerization initiator and thermal polymerization initiator, commercially available compounds can be employed and they are described in Saishin UV Koka Gijutsu (Latest UV Curing Technology), page 159, (publisher: Kazuhiro Takabo), published by Technical Information Institute Co., Ltd. (1991) and the catalogue of Ciba Specialty Chemicals Corp. Two or more kinds of the photopolymerization initiators may be used together.

The photopolymerization initiator is used in a total amount preferably in a range from 0.1 to 15 parts by weight, more preferably in a range from 1 to 10 parts by weight, most preferably in a range from 1 to 6 parts by weight, as to 100 parts by weight of the curable compound (B) in the curable composition for forming the antiglare layer.

Examples of the photopolymerization initiator according to the invention include specifically an acetophenone, a benzoin, a benzophenone, a ketal, an anthraquinone, a thioxanthone, an azo compound, a peroxide (for example, those described in JP-A-2001-139663), a 2,3-dialkyldione compound, a disulfide compound, a fluoroamine compound, an aromatic sulfonium, a lophine dimer, an onium salt, a borate salt, an active ester, a active halogen, an inorganic complex and a coumarin. In addition, it is preferred to use a phosphine oxide photopolymerization initiator in view of proceeding curing in the inside of the antiglare layer. As the phosphine oxide photopolymerization initiator according to the invention, that causing n−π* transition at the time of light absorption and having a photobleaching effect and specifically 2,4,6-trimethylbenzoyl diphenylphosphine oxide or bis(2,4,6-trimethylbenzoyl)phenylphosphine oxide is preferably exemplified.

Preferred examples of the commercially available photo radical polymerization initiator include KAYACURE (DETX-S, B3P-100, BDMK, CTX, BMS, 2-EAQ, ABQ, CPTX, EPD, ITX, QTX, BTC, MCA and the like) produced by Nippon Kayaku Co., Ltd., IRGACURE (651, 184, 500, 819, 907, 369, 1173, 1870, 2959, 4265, 4263, 127 and the like) and DAROCUR (TPO, 1173) produced by BASF, ESACURE (KIP100F, KB1, EB3, BP, X33, KT46, KT37, KIPISO, TZT) produced by Sartomer Company, Inc., and a combination thereof.

### [Surfactant]

The curable composition for forming the antiglare layer according to the invention preferably contains either a fluorine-based surfactant or a silicone-based surfactant or both of them in order to ensure uniformity of surface state by suppressing particularly, for example, coating unevenness, drying unevenness or spot defect. In particular, the fluorine-based surfactant can be preferably used because it exhibits an effect for improving a surface state failure, for example, coating unevenness, drying unevenness or spot defect in a smaller amount of addition. The surfactant provides high-speed coating aptitude while increasing the uniformity of surface state to enhance the productivity.

### [Inorganic Filler]

In the antiglare layer according to the invention, in addition to the light-transmitting resin particle described above, an inorganic filler can be used for the purposes of adjusting the refractive index, adjusting the film strength, decreasing the cure shrinkage and decreasing the reflectance in the case of further providing a low refractive index layer. It is also preferred that the antiglare layer according to the invention contains a fine inorganic filler with a high refractive index which is made of an oxide containing at least one metal element selected from titanium, zirconium, aluminum, indium, zinc, tin and antimony and which has an average particle size ordinarily 0.2 μm or less, preferably 0.1 μm or less, more preferably from 1 μm to 0.06 μm in terms of a an average particle size of the primary particle.

In the case where it is necessary that the refractive index of the matrix is decreased in order to regulate the refractive index difference to the light-transmitting particle, a fine inorganic filler with a low refractive index, for example, a silica fine particle or a hollow silica fine particle can be used as the inorganic filler. A preferred particle size thereof is the same as in the fine inorganic filler with a high refractive index described above.

It is also preferred that the surface of the inorganic filler is subjected to a silane coupling treatment or a titanium coupling treatment, and a surface treating agent having a functional group capable of reacting with the binder species on the filler surface is preferably used.

The amount of the inorganic filler added is in a range from 3 to 90% by weight based on the total solid content of the antiglare layer.

Since the inorganic filler has a particle size sufficiently shorter than the wavelength of light, scattering is not generated and a dispersion prepared by dispersing the inorganic filler in a binder polymer has a property of an optically uniform substance.

### [Polymer Dispersant]

The curable composition for forming the antiglare layer according to the invention may contain a polymer dispersant.

From the standpoint of dispersibility of the particle, denseness of black of the antiglare film obtained and the like, an amine value of the polymer dispersant according to the invention is preferably from 1 to 30 mgKOH/g, and more preferably from 2 to 20 mgKOH/g.

The amine value indicates the total amount of primary, secondary and tertiary amines and is defined as a mg number of potassium hydroxide equivalent to hydrochloric acid necessary for neutralizing 1 g of a sample, and the measuring method therefor is based on JIS K 7237.

As to the amount of the polymer dispersant added according to the invention, the polymer dispersant is preferably contained in a range from 0.01 to 5.0% by weight, more preferably from 0.1 to 5.0% by weight, still more preferably from 0.1 to 3.0% by weight, yet still more preferably from 0.1 to 2.0% by weight, particularly preferably from 0.5 to 2.0% by weight, based on the curable compound. When the amount added is 5.0% by weight or less, the coated layer is excellent in the transparency and is excellent in the adhesion property to the support or the upper layer, and the dispersibility of the light-transmitting resin particle is excellent. When the amount added is 0.01% by weight or more, the antiglare layer obtained is excellent in the brittleness and durability.

The polymer dispersant according to the invention is preferably a block copolymer. Use of the block copolymer enables satisfying both good dispersibility and transparency of the coated layer. The polymer dispersant according to the invention is preferably a urethane block copolymer or an allylamine block copolymer form the standpoint of adsorption. Also, from the standpoint of dispersibility of the particle and adverse effect on the transparency of the coated layer, it is preferably a modified acrylic block copolymer or a modified polyester block copolymer.

The acid value of the polymer dispersant according to the invention may vary depending on the presence or absence and kind of an acidic group responsible for the acid value, but is preferably 30 mgKOH/g or less, and more preferably 20 mgKOH/g or less.

The weight average molecular weight (Mw) of the polymer dispersant according to the invention is preferably in a range from 1,000 to 200,000, more preferably from 1,000 to 100,000, still more preferably from 1,000 to 50,000, from the standpoint of dispersibility, dispersion stability, antiglare property and denseness of black.

The weight average molecular weight is a molecular weight determined by differential refractometer detection with a solvent T-IF in a GPC analyzer using a column TSKgel GMHxL, TSKgeI G4000HxL or TSKgeI G2000HxL (trade names, produced by Tosoh Corp.) and expressed in terms of polystyrene.

Specific compound examples of the polymer dispersant having an amine value from 1 to 30 mgKOH/g according to the invention are not particularly restricted so far as the physical values described above are satisfied. The preferred compound includes a commercially available wet dispersant and, for instance, a wet dispersant produced by BYK-Chemie, for example, DISPERBYK-161 (11), DISPERBYK-162 (13), DISPERBYK-163 (10), DISPERBYK-164 (18), DISPERBYK-166 (20), DISPERBYK-167 (13), DISPERBYK-168 (11), DISPERBYK-182 (13), DISPERBYK-183 (17), DISPERBYK-184 (15), DISPERBYK-185 (17), DISPERBYK-2000 (4), DISPERBYK-2001 (29), DISPERBYK-2009 (4), DISPERBYK-2050 (30), DISPERBYK-2070 (20), DISPERBYK-2163 (10) or DISPERBYK-2164 (14), a pigment dispersant produced by Kusumoto Chemicals, Ltd., for example, DISPARLON DA-703-50, DISPARLON DA-325, DISPARLON DA-7301, DISPARLON 1860 or DISPARLON 7004, or a pigment dispersant produced by Ajinomoto Fine-Techno Co., Inc., for example, AJISPER PB821 (10), AJISPER PB822 (17), AJISPER PB880 (17) or AJISPER PBg81 (17) can be used. In the compounds described above, the value in each parentheses represents the amine value.

The polymer dispersants may be used individually or in combination of two or more thereof.

### [Transparent Support]

The thickness of the transparent support according to the invention is from 20 to 70 μm.

As the transparent support according to the invention, for example, a transparent resin film, a transparent resin plate or a transparent resin sheet is used without restriction. As the transparent resin film, for example, a cellulose acylate film (for example, a cellulose triacetate film (refractive index: 1.48), a cellulose diacetate film, a cellulose acetate butyrate film or a cellulose acetate propionate film), a polyethylene terephthalate film, a polyether sulfone film, a poly(meth)acrylic resin film, a polyurethane resin film, a polyester film, a polycarbonate film, a polysulfone film, a polyether film, a polymethylpentene film, a polyether ketone film or a (meth)acrylonitrile film can be used.

Among them, a cellulose acylate film, which has high transparency and low optical birefringence, is ease in production and is ordinarily used as a protective film of a polarizing plate, is preferred and a cellulose triacetate film is more preferred. According to the invention, the transparent support is preferably a cellulose ester film and a thickness of the cellulose ester film is preferably from 20 to 70 μm. The thickness of the cellulose ester film is more preferably from 20 to 60 μm. The thickness of the cellulose ester film is further more preferably from 30 to 60 μm.

According to the invention, cellulose acetate having a degree of acetylation of 59.0% to 61.5% is preferably used in the cellulose acylate film.

The acetylation degree means an amount of acetic acid combined per unit weight of cellulose. The acetylation degree is determined by the measurement and calculation of the acetylation degree according to ASTM: D-817-91 (testing method of cellulose acetate, etc.). The viscosity average degree of polymerization (DP) of cellulose acylate is preferably 250 or more, more preferably 290 or more.

It is also preferred that the cellulose acylate for use in the invention has an Mw/Mn value (wherein Mw represents a weight average molecular weight and Mn represents a number average molecular weight) determined by gel permeation chromatography close to 1.0, in other words, a narrow molecular weight distribution. Specifically, the Mw/Mn value is preferably from 1.0 to 1.7, more preferably from 1.3 to 1.65, and most preferably from 1.4 to 1.6.

In general, the total substitution degree in cellulose acylate is not distributed evenly ⅓ each among hydroxy groups at 2-, 3- and 6-positions, but the substitution degree of the 6-position hydroxy group tends to decrease. According to the invention, it is preferred that the substitution degree of the 6-position hydroxy group is higher than those of the 2- and 3-position hydroxy groups. The substitution degree of the 6-position hydroxy group with an acyl group is preferably 32% or more, more preferably 33% or more, particularly preferably 34% or more, of the total substitution degree. Further, it is preferred that the substitution degree of the 6-position acyl group in cellulose acylate is 0.88 or more. The 6-position hydroxy group may be substituted with an acyl group having a carbon number of 3 or more, for example, a propionyl group, a butyroyl group, a valeroyl group, a benzoyl group or an acryloyl group, other than an acetyl group. The substitution degree at each position can be determined by NMR measurement.

As the cellulose acylate, cellulose acetates obtained by using methods described in Paragraph Nos. [0043] to [0044], Example, Synthesis Example 1, Paragraph Nos. [0048] to [0049], Synthesis Example 2, and Paragraph Nos. [0051] to [0052], Synthesis Example 3 of JP-A-11-5851 can be used in the invention.

In the case of using a cellulose acylate film as the transparent support, a known plasticizer can be used in order to regulate, for example, brittleness, processing suitability, moisture permeability or optical properties of support. Preferred examples of the plasticizer include a polycondensation ester having monocarboxylic acid ester derivatives at both terminals obtained from a mixture containing an aromatic dicarboxylic acid, an aliphatic dicarboxylic acid, an aliphatic diol having an average number of carbon atoms from 2.0 to 3.0 and a monocarboxylic acid described in JP-A-2010-242050, an esterified compound prepared by esterifying a compound having from 1 to 12 of at least one of a furanose structure and a pyranose structure described in WO 2009/031464, a polyhydric alcohol ester compound described in Japanese Patent No. 4,228,809 and an aromatic group-containing polyester plasticizer described in JP-A-2007-3767.

### [Poly(Meth)Acrylic Resin Film]

The poly(meth)acrylic resin film contains a poly(meth)acrylic resin. The poly(meth)acrylic resin film is obtained, for example, according to molding by extrusion molding of a molding material comprising a resin component containing a (meth)acrylic resin as the main component.

The Tg (glass transition temperature) of the poly(meth)acrylic resin is preferably 115° C. or more, more preferably 120° C. or more, still more preferably 125° C. or more, and particularly preferably 130° C. or more. By containing a poly(meth)acrylic resin having Tg (glass transition temperature) of 115° C. or more as the main component, the poly(meth)acrylic resin film is likely to have excellent durability. The upper limit value of Tg of the poly(meth)acrylic resin is not particularly restricted, but is preferably 170° C. or less in view of molding property and the like.

Any appropriate poly(meth)acrylic resin can be used as the poly(meth)acrylic resin. Examples of the poly(meth)acrylic resin include a poly(meth)acrylate, for example, polymethyl methacrylate, a copolymer of methyl methacrylate and (meth)acrylic acid, a copolymer of methyl methacrylate and a (meth)acrylate, a copolymer of methyl methacrylate, an acrylate and (meth)acrylic acid, a copolymer of methyl (meth)acrylate and styrene (for example, MS resin), and a polymer having an alicyclic hydrocarbon group (for example, a copolymer of methyl methacrylate and cyclohexyl methacrylate or a copolymer of methyl methacrylate and norbornyl (meth)acrylate). Preferred examples thereof include a C1 to C6 alkyl poly(meth)acrylate, for example, methyl poly(meth)acrylate. More preferred examples thereof include a methyl methacrylate resin containing as the main component methyl methacrylate (50 to 100% by weight, preferably 70 to 100% by weight).

Specific examples of the poly(meth)acrylic resin include ACRYPET VH and ACRYPET VRL20A produced by Mitsubishi Rayon Co., Ltd., and a poly(meth)acrylic resin having a high Tg obtained by intramolecular crosslinking or intramolecular cyclization reaction.

According to the invention, a poly(meth)acrylic resin having a glutaric anhydride structure, a poly(meth)acrylic resin having a lactone ring structure or a poly(meth)acrylic resin having a glutarimide structure is preferably used as the poly(meth)acrylic resin because the resin has high heat resistance, high transparency and high mechanical strength.

Examples of the poly(meth)acrylic resin having a glutaric anhydride structure include poly(meth)acrylic resins each having a glutaric anhydride structure described, for example, in JP-A-2006-283013, JP-A-2006-335902 and JP-A-2006-274118.

Examples of the poly(meth)acrylic resin having a lactone ring structure include poly(meth)acrylic resins each having a lactone ring structure described, for example, in JP-A-2000-230016, JP-A-2001-151814, JP-A-2002-120326, JP-A-2002-24544 and JP-A-2006-146084.

Examples of the poly(meth)acrylic resin having a glutarimide structure include poly(meth)acrylic resins each having a glutarimide structure described, for example, in JP-A-2006-309033, JP-A-2006-317560, JP-A-2006-328329, JP-A-2006-328334, JP-A-2006-337491, JP-A-2006-337492, JP-A-2006-337493, JP-A-2006-337569 and JP-A-2007-9182.

The content of the poly(meth)acrylic resin in the poly(meth)acrylic resin film is preferably from 50 to 100% by weight, more preferably from 50 to 99% a by weight, still more from 60 to 98% by weight, and particularly from 70 to 97% by weight. When the content of the poly(meth)acrylic resin in the poly(meth)acrylic resin film is less than 50% by weight, the high heat resistance and high transparency inherent in the poly(meth)acrylic resin may not be sufficiently reflected.

The content of the poly(meth)acrylic resin in the molding material used in the molding of poly(meth)acrylic resin film is preferably from 50 to 100% by weight, more preferably from 50 to 99% by weight, still more from 60 to 98% by weight, and particularly from 70 to 97% by weight. When the content of the poly(meth)acrylic resin in the molding material used in the molding of poly(meth)acrylic resin film is less than 50% by weight, the high heat resistance and high transparency inherent in the poly(meth)acrylic resin may not be sufficiently reflected.

The poly(meth)acrylic resin film may contain a thermoplastic resin other than the poly(meth)acrylic resin. Examples of the thermoplastic resin other than the poly(meth)acrylic resin include an olefin polymer, for example, polyethylene, polypropylene, a copolymer of ethylene and propylene or a poly(4-methyl-1-pentene); a halogenated vinyl polymer, for example, a vinyl chloride resin, a vinylidene chloride resin or a chlorinated vinyl resin; an acrylic resin, for example, polymethyl methacrylate; a styrene polymer, for example, polystyrene, a copolymer of styrene and methyl methacrylate, a copolymer of styrene and acrylonitrile or a block copolymer of acrylonitrile, butadiene and styrene; an polyester, for example, polyethylene terephthalate, polybutylene terephthalate or polyethylene naphthalate; a polyamide, for example, nylon 6, nylon 66 or nylon 610; a polyacetal; a polycarbonate; a polyphenylene oxide; a polyphenylene sulfide; a polyether ether ketone; a polysulfone; a polyether sulfone; a polyoxybenzylene; a polyamideimide; and a rubber polymer, for example, an ABS resin or ASA resin having blended therein a polybutadiene rubber or acrylic rubber.

The content of the other thermoplastic resin in the poly(meth)acrylic resin film is preferably from 0 to 50% by weight, more preferably from 0 to 40% by weight, still more from 0 to 30% by weight, and particularly from 0 to 20% by weight.

The poly(meth)acrylic resin film may contain an additive. Examples of the additive include an antioxidant, for example, a hindered phenol type, a phosphorus type or a sulfur type; a stabilizer, for example, a light-resistant stabilizer, a weather-resistant stabilizer or a thermal stabilizer; a reinforcement, for example, a glass fiber or a carbon fiber; an ultraviolet absorber, for example, phenyl salicylate, (2,2′-hydroxy-5-methylphenyl)benzotriazole or 2-hydroxybenzophenone; a near infrared absorber; a flame retardant, for example, tris(dibromopropyl) phosphate, triallyl phosphate or antimony oxide; an antistatic agent, for example, an anionic, cationic or nonionic surfactant; a coloring agent, for example, an inorganic pigment, an organic pigment or a dye; an organic or inorganic filler; a resin modifier; an organic or inorganic filler; a plasticizer; a lubricant; an antistatic agent; a flame retardant; and retardation decreasing agent.

The content of the additive in the poly(meth)acrylic resin film is preferably from 0 to 5% by weight, more preferably from 0 to 2% by weight, and still more preferably from 0 to 0.5% by weight.

The method for producing the poly(meth)acrylic resin film is not particularly restricted and the poly(meth)acrylic resin film is produced, for example, by thoroughly mixing the poly(meth)acrylic resin, other polymer, additive and the like by any appropriate mixing method to prepare a thermoplastic resin composition and then forming the thermoplastic resin composition into a film. Alternatively, a solution containing the poly(meth)acrylic resin and a solution containing the other polymer, additive and the like are separately prepared, these solutions are mixed to prepare an uniform mixed solution and then a film is formed using the solution.

In order to produce the thermoplastic resin composition, the raw materials for film described above are preblended by any appropriate mixing machine, for example, an omni mixer and the mixture obtained is extruded and kneaded. In this case, the mixing machine used for the extrusion and kneading is not particularly restricted and any appropriate mixing machine, for example, an extruder, e.g., a single screw extruder or a twin screw extruder or a pressure kneader can be used.

Examples of the method for forming a film include any appropriate film forming method, for example, a solution cast method (solution casting method), a melt extrusion method, a calendaring method or a compression molding method. Of the film forming methods, the solution cast method (solution casting method) or melt extrusion method is preferred.

Examples of the solvent for use in the solution cast method (solution casting method) include an aromatic hydrocarbon, for example, benzene, toluene or xylene; an aliphatic hydrocarbon, for example, cyclohexane or decalin; an ester, for example, ethyl acetate or butyl acetate; a ketone, for example, acetone, methyl ethyl ketone or methyl isobutyl ketone; an alcohol, for example, methanol, ethanol, isopropanol, butanol, isobutanol, methyl cellosolve, ethyl cellosolve or butyl cellosolve; an ether, for example, tetrahydrofuran or dioxane; a halogenated hydrocarbon, for example, dichloromethane, chloroform or carbon tetrachloride; dimethylformamide; and dimethylsulfoxide. The solvents may be used individually or in combination of two or more thereof.

Examples of the apparatus for performing the solution cast method (solution casting method) include a drum-type casting machine, a band-type casting machine and a spin coater.

Examples of the melt extrusion method include a T-die method and an inflation method. The film forming temperature is preferably from 150 to 350° C., and more preferably from 200 to 300° C.

In the case of forming a film by the T-die method, a T-die is attached to a tip end of a known single screw extruder or twin screw extruder, and a film extruded in a film shape is wound up to obtain a roll-shaped film. At this time, by applying stretching in an extrusion direction while appropriately adjusting the temperature of the wind-up roll, the film may be also uniaxially stretched. Further, by stretching the film in a direction perpendicular to the extrusion direction, simultaneous biaxial stretching, sequential biaxial stretching or the like may also be performed.

The poly(meth)acrylic resin film may be any of an unstretched film and a stretched film. In the case of the stretched film, the film may be any of a uniaxially stretched film and a biaxially stretched film. In the case of the biaxially stretched film, the film may be any of a simultaneously biaxially stretched film and a sequentially biaxially stretched film. In the case where the film is stretched biaxially, the mechanical strength increases and the film performance is improved. When other thermoplastic resin is mixed in the poly(meth)acrylic resin film, increase in the retardation can be prevented even when the film is stretched so that optical isotropy can be maintained.

The stretching temperature is preferably in the vicinity of a glass transition temperature of the thermoplastic resin composition which is raw material for film and the specific temperature is preferably in a range from (glass transition temperature−30° C.) to (glass transition temperature+100° C.), and more preferably in a range from (glass transition temperature−20° C.) to (glass transition temperature+80° C.). When the stretching temperature is less than (glass transition temperature−30° C.), a sufficient stretching ratio may not be obtained. On the other hand, when the stretching temperature exceeds (glass transition temperature+100° C.), flowage (flow) of the resin composition occurs and stable stretching may not be performed.

The stretching ratio defined by an area ratio is preferably from 1.1 to 25 times, and more preferably from 1.3 to 10 times. When the stretching ratio is less than 1.1 times, the improvement in toughness involved in the stretching may not be achieved. When the stretching ratio exceeds 25 times, the effect to be obtained by increasing the stretching ratio may not be recognized.

The stretching speed is preferably from 10 to 20,000%/min, more preferably from 100 to 10,000%/min in one direction. When the stretching speed is less than 100%/min, it takes time to obtain a sufficient stretching ratio and a production cost may increase. When the stretching speed exceeds 20,000%/min, breaking of the stretched film or the like may occur.

The poly(meth)acrylic resin film may be subjected to heat treatment (annealing) or the like after stretching treatment in order to stabilize its optical isotropy and mechanical characteristics. As to the conditions of the heat treatment, any appropriate condition may be adopted.

The thickness of the poly(meth)acrylic resin film is preferably from 5 to 200 μm, and more preferably from 10 to 100 μm. When the thickness is less than 5 μm, crimp may be increased by conducting the durability test of a polarizing plate, in addition to the decrease in strength. When the thickness exceeds 200 μm, the moisture permeability decreases so that in case of using an aqueous adhesive, the drying rate of water which is a solvent of the adhesive may decrease, in addition to degradation of the transparency.

The wetting tension of the surface of the poly(meth)acrylic resin film is preferably 40 mN/m or more, more preferably 50 mN/m or more, and still more preferably 55 mN/m or more. When the wetting tension of the surface is 40 mN/m or more, the adhesion strength between the poly(meth)acrylic resin film and a polarizer is further increased. In order to adjust the wetting tension of the surface, any appropriate surface treatment may be performed. Examples of the surface treatment include a corona discharge treatment, a plasma treatment, ozone spraying, an ultraviolet ray irradiation, a flame treatment and a chemical treatment. Of the treatments, a corona discharge treatment or a plasma treatment is preferred.

A polyethylene terephthalate film is preferably used in the invention due to its excellent transparency, mechanical strength, planarity, chemical resistance and moisture resistance, in addition to its low price. The transparent plastic film is more preferably subjected to an easy adhesion treatment in order to further improve the adhesion strength between the transparent plastic film and a hardcoat layer provided thereon. As a commercially available optical PET film having an easy adhesion layer, COSMOSHINE A4100 and A4300 (produced by Toyobo Co., Ltd.) are exemplified.

The physical properties of the antiglare layer and antiglare film according to the invention are described below.

In the antiglare layer of the antiglare film according to the invention, the smectite clay organic complex (C) can be uniformly dispersed. Due to the function of the smectite clay organic complex (C) uniformly dispersed, the resin particles (A) can be uniformly aggregated in the antiglare layer and it is preferred that the antiglare layer has not been undergone phase separation.

The term “the smectite clay organic complex (C) is uniformly dispersed” as used herein means that the smectite clay organic complex (C) is randomly dispersed in the antiglare layer without any uneven distribution other than the uneven distribution around the resin particle (A). This can be observed, for example, by a transmission electron microscope.

The term “the antiglare layer has not been undergone phase separation” as used herein means that the phase separation between a phase containing the smectite clay organic complex (C) in a relatively large amount and a phase not containing the smectite clay organic complex (C) or containing the smectite clay organic complex (C) in a relatively small amount does not occur. This can be observed, for example, by a transmission electron microscope.

The thickness of the antiglare layer of the antiglare film according to the invention is from 3.0 to 10.0 μm. The thickness is preferably from 3.0 to 7.0 μm, more preferably from 3.0 to 6.0 μm, and further more preferably from 3.0 to 5.0 μm. By setting the thickness in the range described above, the curl of the antiglare layer associated with cure shrinkage of the curable compound in the antiglare layer can be reduced and the antiglare property and denseness of black can be well regulated.

The thickness of the antiglare layer according to the invention means a thickness of layer containing only the component of the antiglare layer. In the case where the transparent support is composed of a thermoplastic resin, it may happen that the component of the antiglare layer penetrates into the transparent support or that a mixed layer composed of the thermoplastic resin component forming the support and the component of the antiglare layer is formed. The presence of such a layer can be confirmed by reflection or transmission electron microscope observation of a cross-section of the optical film or analysis according to a time-of-flight secondary ion mass spectrometer (TOF-SIMS). When the penetration layer or mixed layer is formed, the thickness of the penetration layer or mixed layer should not be included in the thickness of the antiglare layer.

In the antiglare film according to the invention, an average tilt angle θ of the antiglare film surface on the side of the antiglare layer is preferably from 0.15 to 1.50°. The average tilt angle is more preferably from 0.20 to 1.00°, and most preferably from 0.30 to 0.95°. When the average tilt angle is larger than 1.50°, the bleached color feeling increases and the contrast in a bright room deteriorates, whereas when it is smaller than 0.15°, the reflection of image increases.

In the invention, the average tilt angle is determined according the method described below. Specifically, apexes of a triangle having an area of 0.5 to 2 square micrometers are assumed to be on a transparent support plane. An angle between the normal line of a triangular plane formed by connecting three points at which three perpendicular lines extended vertically and upwardly from the apexes intersect with the film surface and a perpendicular line extended vertically and upwardly from the transparent support is defined as a tilt angle of the surface. An average value of the tilt angles at all the measurement points when an area of 250,000 square micrometers (0.25 square millimeters) or more on the transparent support is divided into the triangles and measured is determined as the average tilt angle.

The antiglare film according to the invention preferably has haze (total haze) of 5.0% or less. The haze can be measured by the procedures described below in the invention.

(1) The haze value (H) (total haze) of the film is measured according to JIS K 7136.
(2) Several droplets of silicone oil are added to the surface of the low reflective index layer side and the rear surface of the film, the film is interposed between two glass plates (Micro Slide Glass No. S9111 produced by Matsunami Glass Ind., Ltd.) each having a thickness of I am, the two glass plates and the film completely come in close contact optically with each other, and the haze is measured in the state where the surface haze is removed. A value obtained by subtracting a haze, which is separately measured in the state where only the silicone oil is interposed between two glass plates, from the haze measured above is calculated as the internal haze (Hi) of the film.
(3) A value obtained by subtracting the internal haze (Hi) calculated in (2) above from the total haze (H) measured in (1) above is calculated as the surface haze (H-1s).

The antiglare film according to the invention preferably has haze (total haze) of 5.0% or less. Of the total haze, the internal haze resulting from internal scattering of the antiglare film is preferably from 0 to 5.0%, more preferably from 0 to 4.0% A, and most preferably from 0.1 to 2.5%.

When the internal haze of the antiglare film is too large, the in-plane contrast decreases. The surface haze obtained by the calculation method according to the invention is preferably from −2.0 to 5.0%, more preferably from −1.0 to 3.0%, and most preferably from 0.0 to 2.5%.

In the invention, one or more other optically functional layers may be stacked in addition to the antiglare layer according to the invention as described below and in the case where the internal scattering property is deliberately provided, it should not be precluded to design an optical film in which the internal haze of a stacked antiglare film as a whole exceeds 5.0%.

As to the surface irregular shape of the antiglare film according to the invention, the centerline average roughness Ra is preferably from 0.02 to 0.15 μm, more preferably from 0.03 to 0.10 μm, and most preferably from 0.03 to 0.09 μm. Due to the aggregation of the resin particle (A) to a suitable extent by the function of the smectite clay organic complex (C) uniformly distributed in the antiglare layer, the surface irregular shape of the antiglare film in the range of Ra described above can be achieved. When the Ra is too large, the contrast in a bright room deteriorates, whereas when the Ra is too small, the reflection of image increases. The 10-point average roughness Rz is preferably approximately from 3 to 10 times the Ra. The average peak to valley distance Sm is preferably from 20 to 200 μm, more preferably from 30 to 120 μm, and most preferably from 30 to 100 μm. The centerline average roughness Ra and average peak to valley distance Sm are measured according to JIS B 0601:2001.

As to a preferred range of glossiness of the antiglare film according to the invention, the glossiness at 60° is preferably from 70 to 100%, more preferably from 80 to 95%, and most preferably from 80 to 90%, and the glossiness at 200 is preferably from 20 to 80%, and more preferably from 25 to 70%. The glossiness is measured according to JIS Z 8741.

### [Construction of Antiglare Film]

The antiglare film according to the invention has, in its simplest form, a construction in which the antiglare layer is provided on the transparent support by coating.

Examples of preferred layer construction of the antiglare film according to the invention are set forth below, but the invention should not be construed as being limited thereto.

Support/antiglare layer
Support/hardcoat layer/antiglare layer
Support/antiglare layer/hardcoat layer
Support/antiglare layer/low refractive index layer
Support/hardcoat layer/antiglare layer/low refractive index layer
Support/antiglare layer/hardcoat layer/low refractive index layer

### [Low Refractive Index Layer]

A low refractive index layer may also be formed on the antiglare layer according to the invention. The low refractive index layer has a refractive index lower than that of the antiglare layer. The thickness of the low refractive index layer is preferably from 50 to 200 μm, more preferably from 70 to 150 μm, and most preferably from 80 μm 120 μm.

The refractive index of the low refractive index layer is lower than that of the layer just under the low refractive index layer and it is preferably from 1.20 to 1.55, more preferably 1.25 to 1.46, and particularly preferably from 1.30 to 1.40. The low refractive index layer is preferably formed by curing a curable composition for forming the low refractive index layer.

Preferred embodiments of the curable composition for low refractive index layer include:

(1) A composition containing a fluorine-containing compound having a crosslinkable or polymerizable functional group;
(2) A composition containing a hydrolysis condensation product of a fluorine-containing organosilane material as the main component; and
(3) A composition containing a monomer having two or more ethylenically unsaturated groups and an inorganic fine particle (particularly preferably an inorganic fine particle having a hollow structure).

It is also preferred for the compositions (1) and (2) to contain an inorganic fine particle. The use of inorganic fine particle having a low refractive index and a hollow structure is particularly preferred from the standpoint of reduction of the refractive index, regulation between the amount of the inorganic fine particle added and the refractive index, and the like.

### (1) Fluorine-Containing Compound Having Crosslinkable or Polymerizable Functional Group

As the fluorine-containing compound having a crosslinkable or polymerizable functional group, a copolymer of a fluorine-containing monomer and a monomer having a crosslinkable or polymerizable functional group is exemplified. Specific examples of the fluorine-containing polymer are described, for example, in JP-A-2003-222702 and JP-A-2003-183322.

The polymer described above may be appropriately used in combination with a curing agent having a polymerizable unsaturated group as described in JP-A-2000-17028. The polymer may also be used in combination with a compound having a fluorine-containing polyfunctional polymerizable unsaturated group as described in JP-A-2002-145952. Examples of the compound having a polyfunctional polymerizable unsaturated group include the monomers having two or more ethylenically unsaturated groups as described in the curable resin compound of the antiglare layer above. Hydrolysis condensation products of organosilane described in JP-A-2004-170901 are also preferred, and hydrolysis condensation products of organosilane having a (meth)acryloyl group are particularly preferred. These compounds are particularly preferred to exhibit the large combined effects of improving the scratch resistance in case of using together with the polymer having a polymerizable unsaturated group.

When the polymer per se does not have sufficient curability, the necessary curability can be imparted by blending a crosslinkable compound. For example, in the case where the polymer has a hydroxy group, it is preferred to use various amino compounds as curing agents. The amino compound used as the crosslinkable compound is, for example, a compound having two or more same or different groups selected from hydroxyalkylamino groups and alkoxyalkylamino groups. Specific examples thereof include a melamine compound, a urea compound, a benzoguanamine compound and a glycoluril compound. For curing of the compound, an organic acid or a salt thereof is preferably used.

### (2) Composition Containing Hydrolysis Condensation Product of Fluorine-Containing Organosilane Material as Main Component

The composition containing a hydrolysis condensation product of a fluorine-containing organosilane compound as the main component is also preferred because it has low refractive index and exhibits high hardness on the surface of coated layer. A condensation product of a compound containing a hydrolyzable silanol group at one terminal or both terminals of a fluorinated alkyl group and tetraalkoxysilane is preferred. Specific examples of the composition are described in JP-A-2002-265866 and Japanese Patent No. 317,152.

### (3) Composition Containing Monomer Having Two or More Ethylenically Unsaturated Groups And Inorganic Fine Particle Having Hollow Structure

A still another preferred embodiment is a low refractive index layer comprising a particle of low refractive index and a binder. The particle of low refractive index may be an organic or inorganic particle and is preferably a particle having a hollow therein. Specific examples of the hollow particle include silica particles described in JP-A-2002-79616. The refractive index of the particle is preferably from 1.15 to 1.40, and more preferably from 1.20 to 1.30. The binder includes the monomer having two or more ethylenically unsaturated groups described with respect to the antiglare layer.

It is preferred to add the photo radical polymerization initiator or thermal radical polymerization initiator described above to the composition for the low refractive index layer which can be used in the invention. When the composition contains a radical polymerizable compound, the polymerization initiator may be used in an amount from 1 to 10 parts by weight, preferably from 1 to 5 parts by weight, based on the radical polymerizable compound.

In the low refractive index layer for use in the invention, an inorganic particle may be used together. A fine particle having a particle size corresponding to 15 to 150%, preferably 30 to 100%, more preferably 45 to 60%, of the thickness of the low refractive index layer can be used in order to impart the scratch resistance.

A known polysiloxane-based or fluorine-based antifouling agent, lubricant or the like may be appropriately added to the low refractive index layer according to the invention in order to impart a characteristic, for example, an antifouling property, water resistance, chemical resistance or slippage.

As an additive having a polysiloxane structure, a reactive group-containing polysiloxane (for example, “KF-100T”, “X-22-169AS”, “KF-102”, “X-22-37011E”, “X-22-164B”, “X-22-5002”, “X-22-173B”, “X-22-1741”, “X-22-167B” and “X-22-161AS” (trade names, produced by Shin-Etsu Chemical Co., Ltd.), “AK-5”, “AK-30” and “AK-32” (trade names, produced by Toagosei Co., Ltd.), and “SILAPLANE FM0725” and “SILAPLANE FM0721” (trade names, produced by Chisso Corp.) is also preferably added. Silicone compounds described in Tables 2 and 3 in JP-A-2003-112383 are also preferably used.

The fluorine-based compound is preferably a compound having a fluoroalkyl group. The fluoroalkyl group preferably has from 1 to 20 carbon atoms, and more preferably from 1 to 10 carbon atoms. The fluoroalkyl group may have a straight-chain structure (for example, —CF₂CF₃, —Cl₂(CF₂)₄H, —CH₂(CF₂)₈CF₃ or —CH₂CH₂(CF₂)₄H), a branched structure (for example, —CH—(CF₂, —CH₂CF(CF₃)₂, —CH(CH₃)CF₂CF₃ or —CH(CH₃)(CF₂)₈CF₂H) or an alicyclic structure (preferably a 5-membered or 6-membered ring, for example, a perfluorocyclohexyl group, a perfluorocyclopentyl group or an alkyl group substituted with a perfluorocyclohexyl group or perfluorocyclopentyl group), or may include an ether bond (for example, —CH₂OCH₂C₂CF₃, —CH₂CH₂OCH₂C4F₅H, —Cl₂CH₂OCH₇C2C₈F₁₇ or —CH₂CH₂OCF₂CF₂OCF₂CF₂H). A plurality of the fluoroalkyl groups may be included in the same molecule.

It is preferred that the fluorine-based compound further has one or more substituents capable of contributing to the formation of bond or compatibility with the coating of the low refractive index layer. The substituents may be the same as or different from each other and a plurality of the substituents are preferred. Examples of preferred substituent include an acryloyl group, a methacryloyl group, a vinyl group, an allyl group, a cinnamoyl group, an epoxy group, an oxetanyl group, a hydroxy group, a polyoxyalkylene group, a carboxyl group and an amino group. The fluorine-based compound may be a polymer or oligomer with a compound containing no fluorine atom. There is no particular restriction on the molecular weight of the fluorine-based compound. The content of fluorine atom in the fluorine-based compound is not particularly restricted and is preferably from 20% by weight or more, particularly preferably from 30% to 70% by weight, and most preferably from 40% to 70% by weight. Examples of preferred fluorine-based compound include R-2020, M-2020, R-3833, M-3833 and OPTOOL DAC (trade names, produced by Daikin Industries, Ltd.), and MEGAFAC F-171, F-172 and F-179A and DEFENSA MCF-300 and MCF-323 (trade names, produced by Dainippon Ink & Chemicals, Inc.), but the invention should not be construed as being limited thereto.

The polysiloxane fluorine-based compound or compound having a polysiloxane structure is preferably added in an amount from 0.1 to 10% by weight, particularly preferably from 1 to 5% by weight, based on the total solid content of the low refractive index layer.

### [Hardcoat Layer]

The antiglare film according to the invention may comprise a hardcoat layer in addition to the antiglare layer in order to further impart physical strength of the film. The hardcoat layer may be composed of a stack of two or more layers.

The thickness of the hardcoat layer is ordinarily from about 0.5 to about 50 μm, preferably from 1 to 20 μm, more preferably from 2 μm to 10 μm, most preferably from 3 to 7 μm, from the standpoint of imparting sufficient durability and impact resistant to the optical film. The strength of the hardcoat layer is preferably H or higher, more preferably 2H or higher, most preferably 311 or higher, as measured by a pencil hardness test. A smaller abrasion amount of a test piece of the hardcoat layer after the taper test according to JIS K 5400 is more preferred.

The hardcoat layer is preferably formed by a crosslinking reaction or polymerization reaction of an ionizing radiation-curable resin compound. For example, the hardcoat layer can be formed by coating a coating composition containing an ionizing radiation-curable polyfunctional monomer or polyfunctional oligomer on a transparent plastic film base material, and undergoing a crosslinking reaction or polymerization reaction of the ionizing radiation-curable polyfunctional monomer or polyfunctional oligomer. The functional group of the ionizing radiation-curable polyfunctional monomer or polyfunctional oligomer is preferably a functional group which can be polymerized by light, an electron beam or radiation and more preferably a photocurable functional group. Examples of the photo curable functional group include an unsaturated polymerizable functional group, for example, a (meth)acryloyl group, a vinyl group, a styryl group or an allyl group. Among them, a (meth)acryloyl group is preferred. The monomer having two or more ethylenically unsaturated groups described as the curable resin compound for the antiglare layer is exemplified.

The hardcoat layer may contain a mat particle, for example, a particle of inorganic compound or a resin particle, which has an average particle size from 1.0 to 10.0 μm, preferably from 1.5 to 7.0 μm for the purpose of imparting the internal scattering property.

A high refractive index monomer, inorganic particle or both of them may be added to a binder of the hardcoat layer for the purpose of regulating the refractive index of the hardcoat layer. The inorganic particle has an effect of preventing the cure shrinkage due to the crosslinking reaction in addition to the effect of regulating the refractive index.

### [Coating Method]

Each layer of the antiglare film according to the invention can be formed by the coating method described below, but the invention should not be construed as being limited thereto. A known method, for example, a dip coating method, an air knife coating method, a curtain coating method, a roller coating method, a wire bar coating method, a gravure coating method, a slide coating method, an extrusion coating method (die coating method) (see JP-A-2003-164788) or a microgravure coating method can be used. Among them, a microgravure coating method or a die coating method is preferred.

In the case of coating two or more layers simultaneously, a method of coating simultaneously two or more layers using one coating apparatus (see Japanese Patent No. 4,277,465, JP-A-2007-164166, JP-A-2003-260400, JP-A-7-108213 and JP-A-2007-121426) is preferred. A method of using a slot die coater described in JP-A-2003-260400 is particularly preferred.

### [Drying and Curing Conditions]

Preferred examples with respect to the drying and curing methods in the case where the antiglare layer or the like according to the invention is formed by coating are described below.

According to the invention, it is effective to cure by a combination of irradiation with ionizing radiation and heat treatment before, simultaneously with or after the irradiation. In the antiglare layer according to the invention, the preferred state of being of the resin particle (A) can be formed by the interaction between the resin particle (A) and the smectite clay organic complex (C). By performing the heat treatment before and/or during curing the ionizing radiation curable monomer, a state wherein the interaction of the resin particle (A) and the inorganic stratiform compound is enhanced can be regulated.

In the invention, the heat treatment is not particularly restricted as long as the constituting layers including the transparent support and the antiglare layer of the antiglare film are not damaged. The temperature for the heat treatment is preferably from 40 to 150° C., more preferably from 50 to 130° C., and most preferably from 60 to 110° C. The heat treatment is performed such that the solid content concentration is set to preferably 70% by weight or more, more preferably 80% by weight or more, within 20 seconds after the coating.

The time required for the heat treatment may vary depending, for example, on the molecular weights, interactions with the other components, viscosities of the components used or the like and it is ordinarily from 10 sec to 10 min, preferably from 15 sec to 5 min, and most preferably from 15 sec to 3 min.

There is no particular restriction on the kind of the ionizing radiation. The ionizing radiation includes, for example, an X-ray, an electron beam, an ultraviolet ray, visible light and an infrared ray. The ultraviolet ray is widely used. For example, when a coating layer is ultraviolet ray curable, it is preferred to cure each layer by irradiation with ultraviolet ray of irradiation dose from 10 to 1,000 mJ/cm² by an ultraviolet ray lamp. At the irradiation, the energy described above may be applied at a time or dividedly. It is particularly preferred to divide the irradiation into two or more times from the standpoint of reducing variability of the performance in the in-plane of the coating layer and improving the surface state and textured feeling on the surface. It is preferred that ultraviolet light having a low irradiation dose of 150 mJ/cm² or less is irradiated at an initial stage and then, ultraviolet light having a high irradiation dose of 50 mJ/cm² or more are irradiated and higher irradiation dose is applied at the later stage rather than the initial stage.

### [Polarizing Plate]

The antiglare film according to the invention can be used in a polarizing plate comprising a polarizing film and protective films arranged at both sides of the polarizing film, as one or both protective films to form a polarizing plate having an antiglare property.

The antiglare film according to the invention may be used as one of the protective films and an ordinary cellulose acetate film may be used as the other protective film. A cellulose acetate film which is produced by a solution film-forming method and stretched at a stretching ratio from 10 to 100% in the width direction in the form of a roll film is preferably used as the other protective film.

Also, according to a preferred embodiment, of the two protective films of the polarizing film, the protective film other than the antiglare film according to the invention is an optically-compensatory film having an optically-compensatory layer including an optically anisotropic layer. The use of the optically-compensatory film (retardation film) can improve the viewing angle characteristic of a liquid crystal display screen. As the optically-compensatory film, although a known optically-compensatory film may be used, the optically-compensatory film described in JP-A-2001-100042 is preferred from the standpoint of enlarging the viewing angle.

As the polarizing film, an iodine-based polarizing film, a dye-based polarizing film using a dichroic dye and a polyene-based polarizing film are known. The iodine-based polarizing film and dye-based polarizing film are ordinarily produced using a polyvinyl alcohol film.

As the polarizing film, a known polarizing film or a polarizing film cut from a long polarizing film in which an absorption axis of the polarizing film is neither parallel nor perpendicular to the longitudinal direction. The long polarizing film in which an absorption axis of the polarizing film is neither parallel nor perpendicular to the longitudinal direction is produced by the method described below.

Specifically, the polarizing film is produced according to a stretching method wherein a tension is applied to a polymer film, for example, a polyvinyl alcohol film, continuously supplied while holding both ends of the polymer film using holding means so that the polymer film is stretched at least from 1.1 to 20.0 times in the width direction thereof and while maintaining the difference in running speed between the longitudinal directions of the holding apparatuses at both ends of the film within 3%, a running direction of the film is bent in the state in which both ends of the film is held so that the running direction of the film at the outlet of the process for holding both ends of the film is inclined at an angle of 20 to 70° relative to the actual stretching direction of the film. It is particularly preferred to set the inclination angle to 45° in view of productivity.

With respect to the stretching method of polymer film, detailed description is made in Paragraph Nos. [0020] to [0030] of JP-A-2002-86554.

### [Image Display Device]

The antiglare film or polarizing plate according to the invention can be used in an image display device, for example, a liquid crystal display device (LCD), a plasma display panel (PDP), an electroluminescence display device (ELD) or a cathode ray tube display device (CRT).

### EXAMPLES

The characteristics of the invention will be more specifically described with reference to the examples and comparative examples below. The materials, amounts of use, proportions, contents of treatments, treating procedures and the like can be appropriately altered as long as the gist of the invention is not exceeded. Therefore, the scope of the invention should not be construed as being limited to the specific examples described below.

Unless otherwise indicated specifically, all parts and percentages in the examples are on a weight basis.

### [Synthesis of Synthetic Smectite]

In 10 liter beaker was poured 4 liters of water, 860 g of liquid glass No. 3 (SiO₂: 28%, Na₂O: 9%., molar ratio: 3.22) was dissolved in the water, and 162 g of 95% sulfuric acid was added at a time to the solution with stirring to obtain a silicate solution. Separately, in one liter of water was dissolved 560 g of first grade reagent MgCl₂.6H₂O (purity: 98%), and the solution was added to the silicate solution to prepare a uniform mixed solution. The mixed solution was added dropwise in 3.6 liters of an aqueous 2N NaOH solution with stirring.

The resulting reaction deposit composed of silicon-magnesium complex (homogeneous complex as aggregate of colloidal particles) was immediately filtered by a filtration system of cross flow process (cross flow filter (ceramic membrane filter, pore size: 2 μm, tubular type, filtration area: 400 cm²) produced by NGK Insulators, Ltd.), thoroughly washed with water and added to a solution composed on 200 ml of water and 14.5 g of Li(OCH).H₂O to form slurry. The slurry was subjected to a hydrothermal reaction in an autoclave at 41 kg/cm² and 250° C. for 3 hours. After cooling, the reaction product was taken from the autoclave, dried at 80° C. and pulverized to obtain synthetic smectite having composition of hectorite which is one kind of smectite and being represented by formula shown below.

Na_{0.4}Mg_{2.6}Li_{0.4}Si₄O₁₀(OH)₂

As a result of X-ray diffraction measurement of the synthetic smectite thus-obtained, it was found that a basal spacing calculated from its (001) plane reflection was 12.5 angstroms in air. The cation exchange capacity measured by the methylene blue absorption method was 110 milliequivalent/100 g.

### [Synthesis of Smectite Clay Organic Complex 1]

In 1,000 ml of tap water was dispersed 20 g of the synthetic smectite obtained above and to the dispersion was added 300 ml of a solution prepared by dissolving 11.1 g of trioctyl methyl ammonium chloride (80% content) as a quaternary ammonium salt in pure water (2.2 mmol as trioctyl methyl ammonium chloride), followed by reacting with stirring at room temperature (25° C.) for 2 hours. The resulting product was collected by solid liquid separation, washed to remove the by-produced salts, dried and pulverized to obtain a clay organic complex.

As a result of X-ray diffraction measurement of the clay organic complex obtained, it was found that a basal spacing calculated from its (001) plane reflection was 18.0 angstroms and it was confirmed that the formation of the smectite clay organic complex. The smectite clay organic complex was dispersed in N,N-dimethylformamide to prepare a transparent dispersion. The content of quaternary ammonium salt estimated from nitrogen atomic weight analysis by burning of the clay organic complex was 105 milliequivalent/100 g of smectite.

In the synthesis of smectite clay organic complex, the amount of trioctyl methyl ammonium chloride added was 110 milliequivalent/100 g of synthetic smectite and it was 1.0 time the cation exchange capacity of synthetic smectite.

### [Synthesis of Smectite Clay Organic Complex 2]

Smectite clay organic complex 2 was prepared in the same manner as in Synthesis of Smectite clay organic complex 1 except for adding the equimolar amount of trioctyl ethyl ammonium chloride in place of the trioctyl methyl ammonium chloride to the synthetic clay.

The content of quaternary ammonium salt estimated in the same manner as described above was 105 milliequivalent/100 g of smectite.

### [Synthesis of Smectite Clay Organic Complex 3]

Smectite clay organic complex 3 was prepared in the same manner as in Synthesis of Smectite clay organic complex 1 except for adding the equimolar amount of tristearyl methyl ammonium chloride in place of the trioctyl methyl ammonium chloride to the synthetic clay.

The content of quaternary ammonium salt estimated in the same manner as described above was 105 milliequivalent/100 g of smectite.

### [Synthesis of Smectite Clay Organic Complex 4]

Smectite clay organic complex 4 was prepared in the same manner as in Synthesis of Smectite clay organic complex 1 except for adding the equimolar amount of tristearyl ethyl ammonium chloride in place of the trioctyl methyl ammonium chloride to the synthetic clay.

The content of quaternary ammonium salt estimated in the same manner as described above was 105 milliequivalent/100 g of smectite.

### [Synthesis of Smectite Clay Organic Complex 5]

Smectite clay organic complex 5 was prepared in the same manner as in Synthesis of Smectite clay organic complex 1 except for adding the equimolar amount of dimethyl dioctadecyl ammonium chloride in place of the trioctyl methyl ammonium chloride to the synthetic clay.

The content of quaternary ammonium salt estimated in the same manner as described above was 105 milliequivalent/100 g of smectite.

### [Synthesis of Smectite Clay Organic Complex 6]

Smectite clay organic complex 6 was prepared in the same manner as in Synthesis of Smectite clay organic complex 1 except for adding the equimolar amount of the quaternary ammonium salt represented by formula shown below in place of the trioctyl methyl ammonium chloride to the synthetic clay.

The content of quaternary ammonium salt estimated in the same manner as described above was 102 milliequivalent/100 g of smectite.

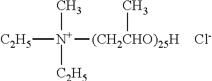

### [Synthesis of Smectite Clay Organic Complex 11]

Smectite clay organic complex 11 was prepared in the same manner as in Synthesis of Smectite clay organic complex 1 except for changing the amount of trioctyl methyl ammonium chloride added to the synthetic smectite to 115 milliequivalent/100 g of synthetic smectite.

The content of quaternary ammonium salt estimated in the same manner as described above was 110 milliequivalent/100 g of smectite.

### [Synthesis of Smectite Clay Organic Complex 12]

Smectite clay organic complex 12 was prepared in the same manner as in Synthesis of Smectite clay organic complex 1 except for changing the amount of trioctyl methyl ammonium chloride added to the synthetic smectite to 120 milliequivalent/100 g of synthetic smectite.

The content of quaternary ammonium salt estimated in the same manner as described above was 115 milliequivalent/100 g of smectite.

### [Synthesis of Smectite Clay Organic Complex 13]

Smectite clay organic complex 13 was prepared in the same manner as in Synthesis of Smectite clay organic complex 1 except for changing the amount of trioctyl methyl ammonium chloride added to the synthetic smectite to 105 milliequivalent/100 g of synthetic smectite.

The content of quaternary ammonium salt estimated in the same manner as described above was 100 milliequivalent/100 g of smectite.

### [Synthesis of Smectite Clay Organic Complex 14]

Smectite clay organic complex 114 was prepared in the same manner as in Synthesis of Smectite clay organic complex 1 except for changing the amount of trioctyl methyl ammonium chloride added to the synthetic smectite to 100 milliequivalent/100 g of synthetic smectite.

The content of quaternary ammonium salt estimated in the same manner as described above was 95 milliequivalent/100 g of smectite.

### [Synthesis of Smectite Clay Organic Complex 15]

Smectite clay organic complex 15 was prepared in the same manner as in Synthesis of Smectite clay organic complex 1 except for changing the amount of trioctyl methyl ammonium chloride added to the synthetic smectite to 95 milliequivalent/100 g of synthetic smectite.

The content of quaternary ammonium salt estimated in the same manner as described above was 90 milliequivalent/100 g of smectite.

### (Preparation of Coating Solution for Antiglare Layer)

Each component was mixed with a mixed solvent composed of MIBK (methyl isobutyl ketone) and MEK (methyl ethyl ketone), toluene or ethanol so as to from the composition shown in Table 1 below. The resulting mixture was filtered through a polypropylene filter having a pore diameter of 30 μm to prepare Coating solutions 1 to 26 and R1 to R7 for antiglare layer. The solid content concentration of each coating solution was 35% by weight. In the preparation of the coating solution, the resin particle and smectite clay organic complex are each added in the form of dispersion.

### (Preparation of Dispersion of Resin Particle)

The dispersion of light-transmitting resin particle was prepared by gradually adding the light-transmitting resin particle to a MIBK solution with stirring until the solid content concentration of the dispersion reached 30% by weight followed by stirring for 30 min.

The resin particle used was a crosslinked styrene-methyl methacrylate copolymer particle shown below prepared by appropriately changing a copolymerization ratio of styrene and methyl methacrylate so as to have an average particle size and refractive index shown in Table I below. (produced by Sekisui Plastics Co., Ltd.)

A: Average particle size: 1.5 μm, Refractive index: 1.52
B: Average particle size: 1.5 μm, Refractive index: 1.54
C: Average particle size: 1.5 μm, Refractive index: 1.50
D: Average particle size: 1.5 μm, Refractive index: 1.55
E: Average particle size: 1.0 μm, Refractive index: 1.52
F: Average particle size: 2.0 μm, Refractive index: 1.52
G: Average particle size: 3.0 μm, Refractive index: 1.52
H: Average particle size: 4.5 pin, Refractive index: 1.52
I: Average particle size: 8.0 μm, Refractive index: 1.52
J: Average particle size: 8.0 μm, Refractive index: 1.55
K: Average particle size: 2.5 μm, Refractive index: 1.52

### (Preparation of Dispersion of Smectite Clay Organic Complex)

The dispersion of smectite clay organic complex was prepared by using the total amount of MEK, toluene or ethanol finally used in the coating solution for antiglare layer and gradually adding the smectite clay organic complex to MEK, toluene or ethanol with stirring followed by stirring for 30 min.

The compounds used in the coating solution for antiglare layer are shown below.

PET-30: Mixture of pentaerythritol triacrylate and pentaerythritol tetraacrylate (produced by Nippon Kayaku Co., Ltd.)
IRGACURE 907: Acetophenone photopolymerization initiator (produced by BASF) (indicated as “Irg907” in Table 1 below)
SP-13: Fluorine-based surfactant (molar ratio=60:40) shown below

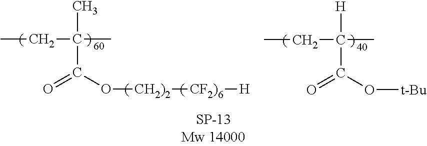

### (Coating of Antiglare Layer)

A triacetyl cellulose film having a thickness of 60 μm (commercially available product produced by Fujifilm Corp.; plasticizer: triphenyl phosphate; draw ratio in the production: conveying direction: 1.14 times, width direction (direction perpendicular to the conveying direction): 0.99 times) was unwound from a roll form, and the antiglare films for Examples 1 to 26 and Comparative Examples 1 to 7 were produced using Coating solutions 1 to 26 and R1 to R7 for antiglare layer so as to have the thickness shown in Table I below, respectively.

Specifically, each of the coating solutions was coated on the triacetyl cellulose film by the die coating method using a slot die described in Example 1 of JP-A-2006-122889 under condition of transport velocity of 30 m/min and dried at 80° C. for 150 sec. Then, the coated layer was cured by irradiation with ultraviolet ray having an illuminance of 400 mW/cm² and irradiation dose of 180 mJ/cm² using an air-cooled metal halide lamp of 160 W/cm (produced by Eye Graphics Co., Ltd.) at an oxygen concentration of about 0.1% under a nitrogen purge to form an antiglare layer, and the resulting film was wound.

### (Saponification Treatment of Antiglare Film)

The antiglare films for Examples 1 to 26 and Comparative Examples 1 to 7 were subjected to saponification treatment and drying under the conditions described below.

Alkali bath: 1.5 mol/dm³ aqueous solution of sodium hydroxide at 55° C. for 120 sec.
First water washing bath: Tap water for 60 sec.
Neutralization bath: 0.05 mol/dm³ sulfuric acid at 30° C. for 20 sec. Second water washing
bath: Tap water for 60 sec.

### Drying: at 120° C. for 60 sec.

### (Formation of Front Polarizing Plate)

A triacetyl cellulose film having a thickness of 60 μm was immersed in a 1.5 mol/l aqueous solution of sodium hydroxide at 55° C. for 2 min, neutralized and washed with water. The resulting triacetyl cellulose film and each of the antiglare films for Examples 1 to 26 and Comparative Examples 1 to 7 after the saponification treatment were adhered to both sides of a polarizer produced by adsorbing iodine to polyvinyl alcohol and stretching to protect the polarizer, thereby forming a front polarizing plate. The triacetyl cellulose film which is the transparent support of each of the antiglare films for Examples 1 to 26 and Comparative Examples 1 to 7 was adhered to the polarizer.

### (Formation of Rear Polarizing Plate)

A rear polarizing plate was formed in the same manner as in the formation of front polarizing plate except for changing the antiglare film to the optically-compensatory film shown below.

### (Formation of Optically-Compensatory Film)

A dope for inner layer and a dope for outer layer each having the composition shown below were prepared.

### <Composition of Dope for Inner Layer>

| | | |
|---|---|---|
| Cellulose acetate C-1 | 100 | parts by |
| (acetyl substitution degree: 2.81, | | weight |
| number average molecular weight: 88,000) | | |
| Retardation developer shown below | 7 | parts by |
| | | weight |
| 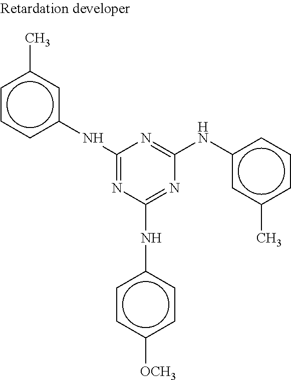 | | |
| Polymer P-2 shown below | 9.0 | parts by |
| | | weight |
| Dye (bluing dye) shown below | 0.000078 | parts by |
| | | weight |
| 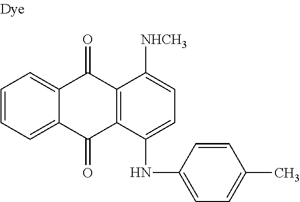 [SMILES: CNc1ccc(Nc2ccc(C)cc2)c2c1C(=O)c1ccccc1C2=O] | | |
| Dichloromethane | 423.9 | parts by |
| | | weight |
| Methanol | 63.3 | parts by |
| | | weight |

### <Composition of Dope for Outer Layer>

| | | |
|---|---|---|
| Cellulose acetate C-1 (acetyl substitution | 100 | parts by weight |
| degree: 2.81, number average molecular | | |
| weight: 88,000) | | |
| Retardation developer shown above | 7 | parts by weight |
| Polymer P-2 shown below | 9.0 | parts by weight |
| Dye (bluing dye) shown above | 0.000078 | parts by weight |
| Silica particle having average particle size of | 0.14 | parts by weight |
| 16 nm (AEROSIL R972, produced by | | |
| Nippon Aerosil Co., Ltd.) | | |
| Dichloromethane | 424.5 | parts by weight |
| Methanol | 63.4 | parts by weight |

Polymer P-2: Polycondensation product having a number average molecular weight of 900 and including dicarboxylic acid residue of TPA/PA/SA/AA (=45/5/30/20% by mole) and diol residue of ethylene glycol (100% by mole) (wherein TPA is terephthalic acid, PA is phthalic acid, SA is sebacic acid, and AA is adipic acid) in which the both terminals are capped with acetyl ester residues.

The dopes for outer layer and inner layer having the compositions described above were simultaneously co-cast uniformly in a width of 2,000 mm on a stainless steel band support using a band casting apparatus so as to form a three-layer structure composed of an outer layer toward the support surface, an inner layer and an outer layer toward the air interface. After the solvents were evaporated until the remaining solvent amount became 40% by weight on the stainless steel band support, the film was peeled from the stainless steel band support. A tension was applied during the peeling to stretch the film so as to have a stretching ratio of 1.02 times in the longitudinal direction (MD). Subsequently, the film was stretched at a rate of 45%/min in the width direction (TD) while both ends of the film were held by a tenter so as to have a stretching ratio of 1.22 times. The remaining solvent amount at the initiation of stretching was 30% by weight. After stretching, the film was dried in a drying zone at 115° C. for 35 min while being transported. After drying, the film was slit to width of 1,340 mm to obtain a cellulose acylate optically compensatory film having a film thickness ratio of the outer layer toward the support, the inner layer and the outer layer toward the air interface of 3:94:3 and a total thickness of 60 μm.

### (Formation of Liquid Crystal Display Device)

Front and rear polarizing plates and a retardation film were removed from a VA mode liquid crystal display device (LC-32DZ3, produced by Sharp Corp.) and instead thereof the respective polarizing plates formed above were arranged so that the triacetyl cellulose film of the front polarizing plate and the optically compensatory film of the rear polarizing plate directed toward a liquid crystal cell and adhered so that the transmission axis matched the polarizing plates of the original display device, thereby forming a liquid crystal display device having the antiglare film.

### (Evaluation of Antiglare Film and Liquid Crystal Display Device)

The evaluations described below were conducted on the antiglare film and liquid crystal display device obtained.

### (1) Thickness of Antiglare Film

The antiglare film obtained was cut in the vertical direction of the support using a microtome. The cross section of the antiglare film was observed by a scanning electron microscope to measure the thickness of the antiglare layer.

(2) State of being of Smectite Clay Organic Complex in Antiglare Layer

The antiglare layer was subjected to Si mapping by SEM-EDX from the surface of antiglare layer and took photograph of 5,000 magnifications to observe the uneven distribution state of Si.

### (3) Antiglare Property

The antiglare film formed was mounted in a liquid crystal television set (LC-32DZ3, produced by Sharp Corp.) and the degree of reflection of a fluorescent lamp at the black display was visually evaluated according to the criteria shown below.

A: The shape of fluorescent lamp is blurred and the change in the blur is very smooth.
B: The shape of fluorescent lamp is blurred but the change in the blur is somewhat sharp.
C: The shape of fluorescent lamp is blurred but the shape is somewhat unsightly.
D: The reflection of fluorescent lamp is unsightly.

### (4) Evaluation of Textured Feeling

Oily black ink was applied on the rare side of the sample and the resulting sample was visually observed under sun light illumination to evaluate according to the criteria shown below.

A: It is not recognized the surface of the film is rough even it is carefully observed.
B: The surface of the film is somewhat rough and it is unsightly.
C: It is recognized at a glance that the surface of the film is rough and it is very unsightly.
(5) Denseness of black

The panel was driven at the black display under an ordinary home environment where TV is watched (about 2,000 lux) and jet-black feeling was visually confirmed according to the criteria shown below.

A: The degree of black is very good.
B: The degree of black is good.
C: Some whitish feeling is recognized but it is at an acceptable level.
D: White blur occurs.
(6) Pencil hardness

The antiglare film formed was evaluated by a pencil hardness test according to JIS K 5600-5-6 using a load of 500 g. The test was conducted five times using a 3H pencil to evaluate a number of times at which scratch did not occur.

### (7) Curl

### (Evaluation Method of F Type Curl)

A curl value of the antiglare film was measured according to the method of ANSI/ASC PH1.29-1985, Method A). A sample obtained by cutting each of the films into a size of 3 mm×35 mm is firmly set vertically on a curl plate so that the sample does not protrude from a support and then subjected to humidity control at 25° C. and a relative humidity of 60% for a humidity control time of 10 hours. After the humidity control, a memory of the curl plate to which a tip of the sample curls is read (=F type curl value). At that time, though ± is expressed depending upon the curl direction of the antiglare film, it is meant that the larger the absolute value, the stronger the curl is.

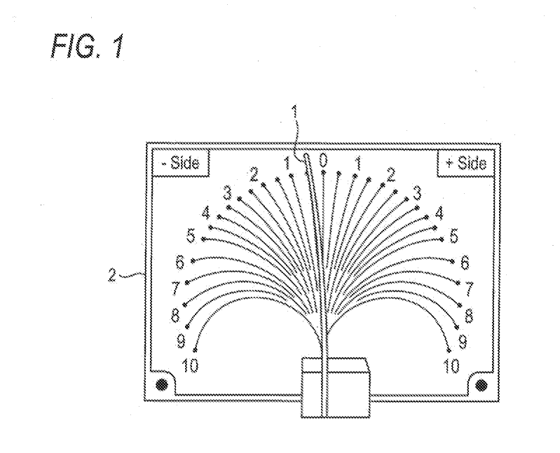

FIG. 1 is a view showing an example of measuring a curl of the antiglare film according to the method of ANSI/ASC PH1.28-1985, Method A). In FIG. 1, the curl of the antiglare film 1 is not more than 0.5 in terms of a memory of a curl plate 2.

The curl (absolute value) of each film was evaluated according to the criteria shown below.

A: Not more than 0.5

### 13: From 0.5 to 1.5

C: More than 1.5

TABLE 1

| | No. of | | Content of | | | | | Content |
|---|---|---|---|---|---|---|---|---|
| | Coating | | Quaternary | | | Average | | of |
| | Solution | Smectite | Ammonium | Amount | | Particle | Refractive | Resin |
| | for | Clay | (/cation | of | Kind of | Size of | Index of | Particle |
| | Antiglare | Organic | exchange | Complex | Resin | Resin | Resin | (% by |
| | Layer | Complex | capacity) | Added | Particle | Particle | Particle | weight) |
| Example 1 | 1 | Complex 1 | ×0.954 | 1.20% | A | 1.5 μm | 1.52 | 3.00% |
| Example 2 | 2 | Complex 2 | ×0.954 | 1.20% | A | 1.5 μm | 1.52 | 3.00% |
| Example 3 | 3 | Complex 3 | ×0.954 | 1.20% | A | 1.5 μm | 1.52 | 3.00% |
| Example 4 | 4 | Complex 4 | ×0.954 | 1.20% | A | 1.5 μm | 1.52 | 3.00% |
| Example 5 | 5 | Complex 11 | ×1.000 | 1.20% | A | 1.5 μm | 1.52 | 3.00% |
| Example 6 | 6 | Complex 12 | ×1.045 | 1.20% | A | 1.5 μm | 1.52 | 3.00% |
| Example 7 | 7 | Complex 13 | ×1.060 | 1.20% | A | 1.5 μm | 1.52 | 3.00% |
| Example 8 | 8 | Complex 14 | ×0.909 | 1.20% | A | 1.5 μm | 1.52 | 3.00% |
| Example 9 | 9 | Complex 15 | ×0.864 | 1.20% | A | 1.5 μm | 1.52 | 3.00% |
| Example 10 | 10 | Complex 1 | ×0.954 | 1.20% | B | 1.5 μm | 1.54 | 3.00% |
| Example 11 | 11 | Complex 1 | ×0.954 | 1.20% | C | 1.5 μm | 1.50 | 3.00% |
| Example 12 | 12 | Complex 1 | ×0.954 | 1.20% | D | 1.5 μm | 1.55 | 3.00% |
| Example 13 | 13 | Complex 1 | ×0.954 | 0.30% | A | 1.5 μm | 1.52 | 3.00% |
| Example 14 | 14 | Complex 1 | ×0.954 | 0.50% | A | 1.5 μm | 1.52 | 3.00% |
| Example 15 | 15 | Complex 1 | ×0.954 | 2.00% | A | 1.5 μm | 1.52 | 3.00% |
| Example 16 | 16 | Complex 1 | ×0.954 | 2.50% | A | 1.5 μm | 1.52 | 3.00% |
| Example 17 | 17 | Complex 1 | ×0.954 | 1.20% | E | 1.0 μm | 1.52 | 3.00% |
| Example 18 | 18 | Complex 1 | ×0.954 | 1.20% | E | 1.0 μm | 1.52 | 3.00% |
| Example 19 | 19 | Complex 1 | ×0.954 | 1.20% | F | 2.0 μm | 1.52 | 3.00% |
| Example 20 | 20 | Complex 1 | ×0.954 | 1.20% | G | 3.0 μm | 1.52 | 3.00% |
| Example 21 | 21 | Complex 1 | ×0.954 | 1.20% | A | 1.5 μm | 1.52 | 1.00% |
| Example 22 | 22 | Complex 1 | ×0.954 | 1.20% | A | 1.5 μm | 1.52 | 6.00% |
| Example 23 | 23 | Complex 1 | ×0.954 | 1.20% | A | 1.5 μm | 1.52 | 7.00% |
| Example 24 | 24 | Complex 1 | ×0.954 | 1.20% | A | 1.5 μm | 1.52 | 3.00% |
| Example 25 | 25 | Complex 1 | ×0.954 | 1.20% | A | 1.5 μm | 1.52 | 3.00% |
| Example 26 | 26 | Complex 1 | ×0.954 | 1.20% | A | 1.5 μm | 1.52 | 3.00% |
| Comparative | R1 | Complex 1 | ×0.954 | 1.20% | A | 1.5 μm | 1.52 | 3.00% |
| Example 1 | | | | | | | | |
| Comparative | R2 | Complex 6 | ×0.927 | 1.20% | A | 1.5 μm | 1.52 | 3.00% |
| Example 2 | | | | | | | | |
| Comparative | R3 | Complex 6 | ×0.927 | 1.20% | A | 1.5 μm | 1.52 | 3.00% |
| Example 3 | | | | | | | | |
| Comparative | R4 | Complex 1 | ×0.954 | 1.20% | I | 8.0 μm | 1.52 | 3.00% |
| Example 4 | | | | | | | | |
| Comparative | R5 | Complex 1 | ×0.954 | 1.20% | J | 8.0 μm | 1.55 | 3.00% |
| Example 5 | | | | | | | | |
| Comparative | R6 | Complex 1 | ×0.954 | 1.20% | A | 1.5 μm | 1.52 | 3.00% |
| Example 6 | | | | | | | | |
| Comparative | R7 | Complex 1 | ×0.954 | 1.20% | H | 4.5 μm | 1.52 | 3.00% |
| Example 7 | | | | | | | | |

| | PET-30 | Irg907 | SP-13 | | MIBK | MEK | Toluene | Ethanol |
|---|---|---|---|---|---|---|---|---|
| | (% by | (% by | (% by | Thickness | (weight | (weight | (weight | (weight |
| | weight) | weight) | weight) | of Layer | ratio) | ratio) | ratio) | ratio) |
| Example 1 | 92.65% | 3.00% | 0.15% | 5 μm | 85 | 15 | | |
| Example 2 | 92.65% | 3.00% | 0.15% | 5 μm | 85 | 15 | | |
| Example 3 | 92.65% | 3.00% | 0.15% | 5 μm | 85 | 15 | | |
| Example 4 | 92.65% | 3.00% | 0.15% | 5 μm | 85 | 15 | | |
| Example 5 | 92.65% | 3.00% | 0.15% | 5 μm | 85 | 15 | | |
| Example 6 | 92.65% | 3.00% | 0.15% | 5 μm | 85 | 15 | | |
| Example 7 | 92.65% | 3.00% | 0.15% | 5 μm | 85 | 15 | | |
| Example 8 | 92.65% | 3.00% | 0.15% | 5 μm | 85 | 15 | | |
| Example 9 | 92.65% | 3.00% | 0.15% | 5 μm | 85 | 15 | | |
| Example 10 | 92.65% | 3.00% | 0.15% | 5 μm | 85 | 15 | | |
| Example 11 | 92.65% | 3.00% | 0.15% | 5 μm | 85 | 15 | | |
| Example 12 | 92.65% | 3.00% | 0.15% | 5 μm | 85 | 15 | | |
| Example 13 | 93.55% | 3.00% | 0.15% | 5 μm | 85 | 15 | | |
| Example 14 | 93.35% | 3.00% | 0.15% | 5 μm | 85 | 15 | | |
| Example 15 | 91.85% | 3.00% | 0.15% | 5 μm | 85 | 15 | | |
| Example 16 | 91.35% | 3.00% | 0.15% | 5 μm | 85 | 15 | | |
| Example 17 | 92.65% | 3.00% | 0.15% | 5 μm | 85 | 15 | | |
| Example 18 | 92.65% | 3.00% | 0.15% | 3 μm | 85 | 15 | | |
| Example 19 | 92.65% | 3.00% | 0.15% | 7 μm | 85 | 15 | | |
| Example 20 | 92.65% | 3.00% | 0.15% | 10 μm | 85 | 15 | | |
| Example 21 | 94.65% | 3.00% | 0.15% | 5 μm | 85 | 15 | | |
| Example 22 | 89.65% | 3.00% | 0.15% | 5 μm | 85 | 15 | | |
| Example 23 | 88.65% | 3.00% | 0.15% | 5 μm | 85 | 15 | | |
| Example 24 | 92.65% | 3.00% | 0.15% | 7 μm | 85 | 15 | | |
| Example 25 | 92.65% | 3.00% | 0.15% | 8 μm | 85 | 15 | | |
| Example 26 | 92.65% | 3.00% | 0.15% | 10 μm | 85 | 15 | | |
| Comparative | 92.65% | 3.00% | 0.15% | 11 μm | 85 | 15 | | |
| Example 1 | | | | | | | | |
| Comparative | 92.65% | 3.00% | 0.15% | 5 μm | 70 | | 30 | |
| Example 2 | | | | | | | | |
| Comparative | 92.65% | 3.00% | 0.15% | 5 μm | 34 | | | 66 |
| Example 3 | | | | | | | | |
| Comparative | 92.65% | 3.00% | 0.15% | 15 μm | 85 | 15 | | |
| Example 4 | | | | | | | | |
| Comparative | 92.65% | 3.00% | 0.15% | 15 μm | 85 | 15 | | |
| Example 5 | | | | | | | | |
| Comparative | 92.65% | 3.00% | 0.15% | 15 μm | 85 | 15 | | |
| Example 6 | | | | | | | | |
| Comparative | 92.65% | 3.00% | 0.15% | 10 μm | 85 | 15 | | |
| Example 7 | | | | | | | | |

| | Distribution | | | Denseness of | |
|---|---|---|---|---|---|
| | of Smectite | Antiglare Property | Textured Feeling | Black | Curl |
| Example 1 | Uniform | A | A | A | A |
| Example 2 | Uniform | A | A | A | A |
| Example 3 | Uniform | A | A | B | A |
| Example 4 | Uniform | A | A | B | A |
| Example 5 | Uniform | A | A | B | A |
| Example 6 | Uniform | B | A | A | A |
| Example 7 | Uniform | C | A | A | A |
| Example 8 | Uniform | A | A | B | A |
| Example 9 | Uniform | A | B | A | A |
| Example 10 | Uniform | A | A | A | A |
| Example 11 | Uniform | A | A | A | A |
| Example 12 | Uniform | A | A | C | A |
| Example 13 | Uniform | B | A | A | A |
| Example 14 | Uniform | A | A | A | A |
| Example 15 | Uniform | A | A | B | A |
| Example 16 | Uniform | A | B | B | A |
| Example 17 | Uniform | A | A | A | A |
| Example 18 | Uniform | A | A | A | A |
| Example 19 | Uniform | B | A | A | A |
| Example 20 | Uniform | A | A | B | B |
| Example 21 | Uniform | A | A | A | A |
| Example 22 | Uniform | A | A | A | A |
| Example 23 | Uniform | A | A | C | A |
| Example 24 | Uniform | A | A | A | A |
| Example 25 | Uniform | B | A | A | B |
| Example 26 | Uniform | B | A | A | B |
| Comparative Example 1 | Uniform | C | A | A | C |
| Comparative Example 2 | Uniform | D | A | A | A |
| Comparative Example 3 | Phase Separation | B | C | A | A |
| Comparative Example 4 | Uniform | B | A | C | C |
| Comparative Example 5 | Uniform | B | A | D | C |
| Comparative Example 6 | Uniform | D | A | A | C |
| Comparative Example 7 | Uniform | A | A | C | B |

From the results shown in Table I the followings are apparent.

It can be seen that the curl occurs due to the cure shrinkage in Comparative Examples 1 and 4 to 7 in which the thickness of the antiglare layer exceeds 10 μm. Also, it can be seen that the denseness of black tends to deteriorate in Comparative Examples 4, 5 and 7 in which the average particle size of the resin grain exceeds 3.0 μm.

It can also be seen that Comparative Example 6 in which the thickness of the antiglare layer exceeds to a large extent the limit of 10 μm even when the average particle size of the resin particle is within the range from 1.0 to 3.0 μm is also poor in the antiglare property.

It is understood that when a phase containing a large amount of the smectite clay organic complex is formed by using a compound outside of formula (I) as the quaternary ammonium salt for intercalation in the smectite clay organic complex and two kinds of specific solvents to cause phase separation, aggregates of the smectite clay organic complex are generated, thereby showing the textured feeling in Comparative Example 3. On the other hand, it is understood that Comparative Example 2 in which a compound outside of formula (I) is used as the quaternary ammonium salt for intercalation in the smectite clay organic complex and the solvent composition is so selected that the smectite clay organic complex is uniformly dispersed (that phase separation does not occur) is poor in the antiglare property.

On the contrary, it can be seen that in Examples 1 to 26 in which the thickness of the antiglare layer is within the range from 3 to 10 μm, the average particle size of the resin particle is within the range from 1.0 to 3.0 μm, and the compound represented by formula (I) is used as the quaternary ammonium salt for intercalation in the smectite clay organic complex, all of the antiglare property, decrease in textured feeling, denseness of black and curl are excellent or at an acceptable level.

### (Formation of Triacetyl Cellulose Film by Using Non-Phosphoric Acid Ester Plasticizer)

### (Preparation of Cellulose Ester Solution A-1)

The composition shown below was charged in a mixing tank, stirred with heating to dissolve respective components to prepare Cellulose ester solution A-1. The acetyl substitution degree of the cellulose ester was measured according to ASTM D-817-91. The viscosity average polymerization degree was measured according to an Uda et al's limiting viscosity method (Kazuo Uda and Hideo Saito, Journal of the Society of Fiber Science and Technology, Japan, Vol. 18, No. 1, pp. 105-120 (192)).

### <Composition of Cellulose Ester Solution A-1>

| | | |
|---|---|---|
| Cellulose ester (acetyl substitution degree of 2.86 and | 100 | parts by |
| viscosity average polymerization degree of 310) | | weight |
| Sugar ester compound 1 shown below | 3.0 | parts by |
| | | weight |
| Sugar ester compound 2 shown below | 1.0 | parts by |
| | | weight |
| Methylene chloride | 375 | parts by |
| | | weight |
| Methanol | 82 | parts by |
| | | weight |
| Butanol | 5 | parts by |
| | | weight |

### (Preparation of Matting Agent Dispersion B-1)

The composition shown below was charged in a disperser and stirred to dissolve respective components to prepare Matting agent dispersion B-1.

### <Composition of Matting Agent Dispersion B-1>

| | | |
|---|---|---|
| Silica particle dispersion (average particle size of 16 nm) | 10.0 | parts by |
| (AEROSIL R972, produced by Nippon Aerosil Co., Ltd.) | | weight |
| Methylene chloride | 62.5 | parts by |
| | | weight |
| Methanol | 14.1 | parts by |
| | | weight |
| Butanol | 0.8 | parts by |
| | | weight |
| Cellulose ester solution A-1 | 10.3 | parts by |
| | | weight |

### (Preparation of Ultraviolet Absorber Solution C-1)

The composition shown below was charged in a mixing tank, stirred with heating to dissolve respective components to prepare Ultraviolet absorber solution C-1.

### <Composition of Ultraviolet Absorber Solution C-1>

| | | |
|---|---|---|
| Ultraviolet absorber (UV-1) shown below | 10.0 | parts by weight |
| Ultraviolet absorber (UV-2) shown below | 10.0 | parts by weight |
| Methylene chloride | 54.3 | parts by weight |
| Methanol | 12.0 | parts by weight |
| Butanol | 0.7 | parts by weight |
| Cellulose ester solution A-1 | 12.9 | parts by weight |

(Sugar ester compound 1) 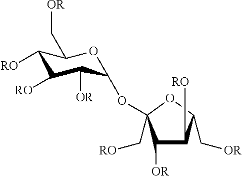
R: Benzoyl or H
Average substitution degree: 5.7
(Sugar ester compound 2) 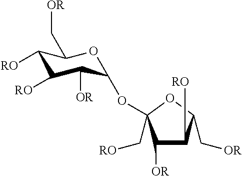
R: Acetyl/Isobutyryl = 2/6
(UV-1) 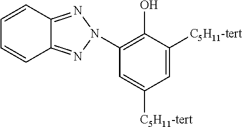
(UV-2)

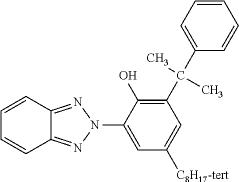

### (Method of Measuring Average Substitution Degree of Sugar Ester Compound)

Regarding a peak in retention time around 31.5 min, a peak in retention time around 27 to 29 min, a peak in retention time around 22 to 25 min, a peak in retention time around 15 to 20 min, a peak in retention time around 8.5 to 13 min and a peak in retention time around 3 to 6 min as a 8 substitution product, a 7 substitution product, a 6 substitution product, a 5 substitution product, a 4 substitution product and a 3 substitution product, respectively, space ratios were measured under HPLC conditions shown below and an average substitution degree relative to a value obtained by totalizing the respective space ratios was calculated.

### <<HPLC Measuring Conditions>>

Column: TSK-gel ODS-100Z (produced by Tosoh Corp.), 4.6×150 mm, Lot No. (P0014)

### Eluent A: H₂O=100

Eluent B: Acetonitrile=100. Both Eluent A and Eluent B containing 0.1% by weight of AcOH (acetic acid) and 0.1% by weight of NEt₃ (triethylamine)
Flow rate: 1 ml/min
Column temperature: 40° C.

### Wavelength: 254 μm

### Sensitivity: AUX2

Injection amount: 101
Rinse solution: THF/H₂O=9/1 (in volume ratio)
Sample concentration: 5 mg/10 ml (THF)

### (Substitution Degree of Sugar Ester Compound)

The average substitution degree is preferably from 5.0 to 6.5, more preferably from 5.3 to 6.2, most preferably from 5.5 to 6.0, from the standpoint of bleeding out (which may generate at 6.5 or more) and water content (which may increase at 5.0 or less). Also, from the standpoint of preventing the generation of bleeding out, the content of the 8 substitution product is preferably 20% by weight or less, more preferably 15% by weight or less, and most preferably 10% by weight or less.

### (Formation of Cellulose Ester Film)

### (Preparation of Dope for Core Layer)

To Cellulose ester solution A-1 were added Sugar ester compound 1 and Sugar ester compound 2 so as to have 8.25 parts by weight of Sugar ester compound 1 and 2.75 parts by weight of Sugar ester compound 2 based on 100 parts by weight of the cellulose ester, and Ultraviolet absorber solution C-1 so as to have 1.2 parts by weight of each of Ultraviolet absorber (UV-1) and Ultraviolet absorber (UV-2) based on 100 parts by weight of the cellulose ester to prepare a dope.

### (Preparation of Dope for Surface Layer 1)

To Cellulose ester solution A-1 were added Ultraviolet absorber solution C-1 so as to have 1.2 parts by weight of each of Ultraviolet absorber (UV-1) and Ultraviolet absorber (UV-2) based on 100 parts by weight of the cellulose ester, then Matting agent dispersion B-1 so as to have 0.026 parts by weight of the silica particle based on 100 parts by weight of the cellulose ester, and methylene chloride so as to account for 85% by weight of the dope solvent to prepare a dope.

### (Preparation of Dope for Surface Layer 2)

To Cellulose ester solution A-1 were added Ultraviolet absorber solution C-1 so as to have 1.2 parts by weight of each of Ultraviolet absorber (UV-1) and Ultraviolet absorber (UV-2) based on 100 parts by weight of the cellulose ester, then Matting agent dispersion B-1 so as to have 0.078 parts by weight of the silica particle based on 100 parts by weight of the cellulose ester, and methylene chloride so as to account for 85% by weight of the dope solvent to prepare a dope.

The dopes obtained were heated at 30° C. and co-cast in a three-layer construction from dies through a cast giesser on a mirror surface stainless steel support of a drum having a diameter of 3 m. The dope for surface layer 1 was cast so as to form a first layer having a dry thickness of 2 μm in contact with the support, the dope for core layer was cast so as to form a second layer having a dry thickness of 54 μm, and the dope for surface layer 2 as cast so as to form a third layer having a dry thickness of 4 μm. The surface temperature of the support was set −7° C., and the casting width was 1,470 mm. The special temperature of the whole casting unit was set at 15° C. The cellulose ester film cast and rotated was dried with dry air of 30° C. on the drum, peeled from the drum at the point 50 cm before the terminal end of casting unit in the state of the residual solvent amount of 240% and clipped the both ends thereof with a pin tenter. At the peeling, the film was stretched by 10% in the conveying direction. Then, while holding the both side of the width direction (direction perpendicular to the conveying direction) of the film with a pin tenter (pin tenter described in FIG. 3 of JP-A-4-1009), the stretching treatment was conducted by 5% in the width direction. The thickness of the cellulose ester film produced was 60 μm.

### (Preparation of Coating Solution for Antiglare Layer)

Each component was mixed with a mixed solvent composed of MIBK (methyl isobutyl ketone) and MEK (methyl ethyl ketone) so as to from the composition shown in Table 2 below. The resulting mixture was filtered through a polypropylene filter having a pore diameter of 30 μm to prepare Coating solutions 101 to 109 for antiglare layer. The solid content concentration of each coating solution was 35% by weight. In the preparation of the coating solution, the resin particle and smectite clay organic complex are each added in the form of dispersion.

### (Coating of Antiglare Layer)

The cellulose ester film described above was unwound from a roll form, and the antiglare films for Examples 101 to 109 were produced by coating on the surface of the third layer using Coating solutions 101 to 109 for antiglare layer so as to have the thickness shown in Table 2 below, respectively, in the same manner as in Example 1. The state of being of smectite clay organic complex, antiglare property, textured feeling, denseness of black and curl were evaluated in the same manner as in Example 1.

TABLE 2

| | No. of | | Content of | | | | | Content |
|---|---|---|---|---|---|---|---|---|
| | Coating | | Quaternary | | | Average | | of |
| | Solution | Smectite | Ammonium | Amount | Kind | Particle | Refractive | Resin |
| | for | Clay | (/cation | of | of | Size of | Index of | Particle |
| | Antiglare | Organic | exchange | Complex | Resin | Resin | Resin | (% by |
| | Layer | Complex | capacity) | Added | Particle | Particle | Particle | weight) |
| Example | 101 | Complex 1 | ×0.954 | 1.20% | K | 2.5 μm | 1.52 | 8.00% |
| 101 | | | | | | | | |
| Example | 102 | Complex 2 | ×0.954 | 1.20% | K | 2.5 μm | 1.52 | 8.00% |
| 102 | | | | | | | | |
| Example | 103 | Complex 3 | ×0.954 | 1.20% | K | 2.5 μm | 1.52 | 8.00% |
| 103 | | | | | | | | |
| Example | 104 | Complex 4 | ×0.954 | 1.20% | K | 2.5 μm | 1.52 | 8.00% |
| 104 | | | | | | | | |
| Example | 105 | Complex 1 | ×0.954 | 1.20% | K | 2.5 μm | 1.52 | 8.00% |
| 105 | | | | | | | | |
| Example | 106 | Complex 1 | ×0.954 | 1.20% | K | 2.5 μm | 1.52 | 8.00% |
| 106 | | | | | | | | |
| Example | 107 | Complex 1 | ×0.954 | 1.20% | K | 2.5 μm | 1.52 | 8.00% |
| 107 | | | | | | | | |
| Example | 108 | Complex 1 | ×0.954 | 1.20% | K | 2.5 μm | 1.52 | 8.00% |
| 108 | | | | | | | | |
| Example | 109 | Complex 1 | ×0.954 | 1.20% | K | 2.5 μm | 1.52 | 8.00% |
| 109 | | | | | | | | |

| | PET-30 | Irg907 | SP-13 | Dispersant | Dispersant | | MIBK | MEK |
|---|---|---|---|---|---|---|---|---|
| | (% by | (% by | (% by | A* (% by | B* (% by | Thickness | (weight | (weight |
| | weight) | weight) | weight) | weight) | weight) | of Layer | ratio) | ratio) |
| Example | 90.65% | 3.00% | 0.15% | 0.30% | | 4 μm | 85 | 15 |
| 101 | | | | | | | | |
| Example | 90.65% | 3.00% | 0.15% | 0.30% | | 4 μm | 85 | 15 |
| 102 | | | | | | | | |
| Example | 90.65% | 3.00% | 0.15% | 0.30% | | 4 μm | 85 | 15 |
| 103 | | | | | | | | |
| Example | 90.65% | 3.00% | 0.15% | 0.30% | | 4 μm | 85 | 15 |
| 104 | | | | | | | | |
| Example | 90.65% | 3.00% | 0.15% | | 0.30% | 4 μm | 85 | 15 |
| 105 | | | | | | | | |
| Example | 90.65% | 3.00% | 0.15% | | 0.30% | 4.5 μm | 85 | 15 |
| 106 | | | | | | | | |
| Example | 90.65% | 3.00% | 0.15% | | 0.30% | 5 μm | 85 | 15 |
| 107 | | | | | | | | |
| Example | 90.65% | 3.00% | 0.15% | | 0.30% | 5.5 μm | 85 | 15 |
| 108 | | | | | | | | |
| Example | 90.65% | 3.00% | 0.15% | | 0.30% | 6 μm | 85 | 15 |
| 109 | | | | | | | | |

| | | | | Denseness of | |
|---|---|---|---|---|---|
| | Distribution of Smectite | Antiglare Property | Textured Feeling | Black | Curl |
| Example 101 | Uniform | A | A | A | A |
| Example 102 | Uniform | A | A | A | A |
| Example 103 | Uniform | A | A | B | A |
| Example 104 | Uniform | A | A | B | A |
| Example 105 | Uniform | A | A | A | A |
| Example 106 | Uniform | A | A | A | A |
| Example 107 | Uniform | A | A | A | A |
| Example 108 | Uniform | A | A | A | A |
| Example 109 | Uniform | A | A | A | A |

*Dispersant A: DISPERBYK 2164 (BYK Chemie), Dispersant B: AJISPER P881 (Ajinimoto Fine-Techno Co., Ltd.)

From the results shown in Table 2, it can be seen that in Examples 101 to 109, all of the antiglare property, decrease in textured feeling, denseness of black and curl are excellent or at an acceptable level same as in Example 1.

### (Coating of Antiglare Layer)

The triacetyl cellulose film having a thickness of 60 μm used in Example I was unwound from a roll form, and the antiglare film for Example 301 was produced in the same manner as in Example I using Coating solution 105 for antiglare layer so as to have a thickness of the antiglare layer of 4 μm.

A triacetyl cellulose film having a thickness of 60 μm (same film as used in Example except for changing the draw ratio in the production as follows: conveying direction: 1.08 times, width direction (direction perpendicular to the conveying direction): 1.15 times) was unwound from a roll form, and the antiglare film for Example 302 was produced in the same manner as in Example I using Coating solution 105 for antiglare layer so as to have a thickness of the antiglare layer of 4 μm,

With respect to the antiglare films of Examples 301 and 302, the state of being of smectite clay organic complex, antiglare property, textured feeling, denseness of black and curl were evaluated in the same manner as in Example 1. As to the antiglare films of Examples 301 and 302, it can be seen that the state of being of smectite clay organic complex is uniform and the antiglare property, textured feeling and denseness of black are excellent similar to those in Example 205.

With respect to the antiglare films of Examples 301, 302 and 205, the pencil hardness was evaluated. It was found that the number of times at which the scratch did not occur was one time in Example 301, three times in Example 302, and four times in Example 205.

### (Formation of (Meth)Acrylic Resin Film)

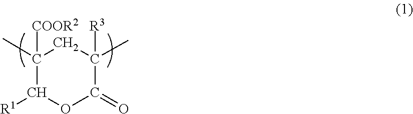

A pellet [a mixture (Tg: 127° C.) of 90 parts by weight of a (meth)acrylic resin having a lactone ring structure represented by formula (I) above wherein R¹ is a hydrogen atom and R² and R³ are methyl groups {copolymerization monomer weight ratio: methyl methacrylate/methyl 2-(hydroxymethyl)acrylate=8/2, lactone ring formation rate: about 100%, content rate of lactone ring structure: 19.4%, weight average molecular weight: 133,000, melt flow rate: 6.5 g/10 min (240° C., 10 kgf), Tg: 131° C.} and 10 parts by weight of an acrylonitrile-styrene (AS) resin {TOYO AS AS20, produced by Toyo Styrene Co., Ltd.}was supplied to a biaxial extruder and melt-extruded in a sheet shape at about 280° C. to obtain a sheet of (meth)acrylic resin containing a lactone ring structure having a thickness of 110 μm. The unstretched sheet was stretched longitudinally by 2.0 times and laterally by 2.4 times under a temperature condition of 160° C. to obtain (Meth)acrylic resin film I (thickness: 40 μm, in-plane retardation And: 0.8 μm, retardation in a thickness direction Rth: 1.5 μm).

Also, (Meth)acrylic resin film 2 (thickness: 20 μm) and (Meth)acrylic resin film 3 (thickness: 10 μm) were obtained in the same manner as above.

### (Corona Discharge Treatment)

One side of the (meth)acrylic resin film obtained above was subjected to a corona discharge treatment (corona discharge electron irradiation amount: 77 W/m²/min).

### (Formation of Easy Adhesion Layer)

An easy adhesive composition was obtained by mixing 16.8 g of polyester urethane (SUPERFLEX 210, solid content: 33%, produced by Dai-Ichi Kogyo Seiyaku Co., Ltd.), 4.2 g of a crosslinking agent (oxazoline-containing polymer, EPOCROS WS-700, solid content: 25%, produced by Nippon Shokubai Co., Ltd.), 2.0 g of 1% by weight aqueous ammonia, 0.42 g of colloidal silica (QUARTRON PL-3, solid content: 20% by weight, produced by Fuso Chemical Co., Ltd.) and 76.6 g of pure water.

The easy adhesive composition thus-obtained was coated on the corona discharge treated surface of (meth)acrylic resin film which had been subjected to the corona discharge treatment by a bar coater (#6) so as to have a thickness after drying of 350 μm. Then, the (meth)acrylic resin film was placed in a hot air drying machine (140° C.) and the easy adhesive composition was dried for about 5 minutes to form an easy adhesion layer (0.3 to 0.5 μm).

A coating solution for antiglare layer was prepared by changing the solvent composition in Coating solution for antiglare layer No. 1 to MIBK:MEK=90:10 and coated on each of (Meth)acrylic resin films 1 to 3 described above on the side opposite to the easy adhesion layer formed. The results similar to those in Example 1 were obtained in all of the distribution of smectite, antiglare property, textured feeling and denseness of black.

Further, a low refractive index layer was coated on each of the antiglare films for Examples 1 to 26 and Comparative Examples 1 to 7. As a result, it was confirmed by using the antiglare film according to the invention that the textured feeling and curl were prevented and more excellent denseness of black could be attained while maintaining the antiglare property.

### [Coating of Low Refractive Index Layer]

### (Preparation of Inorganic Particle Dispersion (B-1))

A silica fine particle having a hollow structure therein was produced in the same manner as in Preparation Example 4 of JP-A-2002-79616 except for changing the conditions for preparation. The silica fine particle in the state of an aqueous dispersion was solvent exchanged with methanol. The final solid content concentration was adjusted to 20% by weigh to obtain a dispersion containing the silica particles having an average particle size of 45 nm, a shell thickness of about 7 nm and a refractive index of 1.30. The dispersion obtained was referred to as Dispersion (B).

To 500 parts by weight of Dispersion (B) were added 15 parts by weight of acryloyloxypropyltrimethoxysilane and 1.5 parts by weight of diisopropoxy aluminum ethyl acetate, and then 9 parts by weights of ion-exchanged water was added thereto. The mixture was allowed to react at 60° C. for 8 hours. The reaction mixture was cooled to room temperature and 1.8 parts by weight of acetyl acetone was added thereto. The resulting mixture was solvent exchanged with MEK by distillation under a reduced pressure while continuously adding MEK in such a manner that the total amount of the solution was maintained almost constant. The final solid content concentration was adjusted to 20% by weight to prepare (Dispersion B-1).

### (Preparation of Coating Solution for Low Refractive Index Layer)

A mixture of 7.6 g of a fluorine-containing polymer (P-12: a fluorine-containing copolymer exemplified in JP-A-2007-293325), 1.4 g of DPHA (mixture of dipentaerythritol pentaacrylate and dipentaerythritol hexaacrylate, produced by Nippon Kayaku Co., Ltd.), 24 g of Dispersion (B-1), 0.46 g of a photopolymerization initiator (IRGACURE 907), 150 g of methyl ethyl ketone and 40 g of propylene glycol monomethyl ether acetate was stirred and filtered through a polypropylene filter having a pore diameter of 5 μm to prepare a coating solution for low refractive index layer.

### (Coating of Low Refractive Index Layer)

The triacetyl cellulose film on which the antiglare layer had been coated was again unwound and the coating solution for low refractive index layer described above was coated on the triacetyl cellulose film by the die coating method using a slot die described above under condition of transport velocity of 30 m/min and dried at 90° C. for 75 sec. Then, the coated layer was irradiated with ultraviolet ray having an illuminance of 400 mW/cm² and irradiation dose of 240 mJ/cm² using an air-cooled metal halide lamp of 240 W/cm (produced by Eye Graphics Co., Ltd.) at an oxygen concentration of 0.01 to 0.1% under a nitrogen purge to form a low refractive index layer having a thickness of 100 μm, thereby preparing an antiglare film having a low refractive index layer. The antiglare film was wound. The refractive index of the low refractive index layer was 1.35.

What is claimed is:

1. An antiglare film comprising an antiglare layer having a thickness of from 3 to 10 μm and a transparent support having a thickness from 20 to 70 μm, wherein the antiglare layer is formed by applying a composition containing the following components (A) to (D) on the transparent support, drying and curing the applied composition:
(A) a resin particle having an average particle size of from 1.0 to 3.0 μm,
(B) a curable compound having two or more curable functional groups in a molecule,
(C) a smectite clay organic complex in which a smectite clay is intercalated with a quaternary ammonium salt represented by the following formula (I), and
(D) a volatile organic solvent;
[(R¹)₃(R²)N]⁺.X⁻ (1)
wherein R¹ and R² are not same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.

2. The antiglare film as claimed in claim 1, wherein the antiglare layer does not undergo phase separation.

3. The antiglare film as claimed in claim 1, wherein R¹ in the formula (1) is an alkyl group having from 6 to 10 carbon atoms.

4. The antiglare film as claimed in claim 1, wherein R² in the formula (I) is an alkyl group having 1 or 2 carbon atoms.

5. The antiglare film as claimed in claim 1, wherein a content of the smectite clay organic complex (C) is from 0.5 to 2.0% by weight in the antiglare layer.

6. The antiglare film as claimed in claim 1, wherein a content of the quaternary ammonium salt in the smectite clay organic complex (C) is from 0.95 to 1.05 times of a cation exchange capacity.

7. The antiglare film as claimed in claim 1, wherein a thickness of the antiglare layer is from 3 to 6 μm.

8. The antiglare film as claimed in claim 1, wherein the smectite clay organic complex (C) is uniformly dispersed in the antiglare layer.

9. The antiglare film as claimed in claim 1, wherein the resin particle (A) is a particle of a copolymer of styrene and methyl methacrylate and a refractive index of the resin particle (A) is from 1.50 to 1.54.

10. The antiglare film as claimed in claim 1, which further comprises a low refractive index layer having a refractive index lower than that of the transparent support, so that the transparent support, the antiglare layer and the low refractive index layer are provided in this order.

11. The antiglare film as claimed in claim 1, which is used as a surface film for liquid crystal display device.

12. A polarizing plate comprising at least one protective film and a polarizing film, wherein at least one of the at least one protective film is the antiglare film as claimed in claim 1 and a surface of the antiglare film on a side of the transparent support is stacked on the polarizing film.

13. An image display device comprising the antiglare film as claimed in claim 1.

14. A method for producing an antiglare film comprising: forming an antiglare layer having a thickness from 3 to 10 μm on one surface of a transparent support having a thickness from 20 to 70 μm by applying a composition containing the following components (A) to (D) on the transparent support, and drying and curing the applied composition:
(A) a resin particle having an average particle size from 1.0 to 3.0 μm,
(B) a curable compound having two or more curable functional groups in a molecule,
(C) a smectite clay organic complex in which a smectite clay is intercalated with a quaternary ammonium salt represented by formula (I) shown below, and
(D) a mixed solvent containing two or more kinds of ketone solvents;
[(R¹)₃(R²)N]⁺.X⁻ (1)
wherein R¹ and R² are not the same, R¹ represents an alkyl group, an alkenyl group or an alkynyl group, each having from 4 to 24 carbon atoms, R² represents an alkyl group, an alkenyl group or an alkynyl group, each having from 1 to 10 carbon atoms, and X⁻ represents an anion.
